SEQUENCE LISTING (7 sequences)

SEQ ID NO: 1 - protein, 269 aa, Bacillus clausii
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 3 - protein, 483 aa, Bacillus sp. AA560
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRGNTHSNFKWRWYHFDGVDWDQSRKLNNRIYKFRGKGWDWEVDTEFGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQKHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

SEQ ID NO: 4 - protein, 483 aa, Bacillus sp. AA560
HHNGTNGTLMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRANTHSNFKWRWYHFDGVDWDQSRKLNNRIYKFRTKAWDWEVDTEFGNYDYLLYADIDMDHPEVVNELRNWGVWYTNTLGLDGFRIDAVKHIKYSFTRDWINHVRSAIGKNMFAVAEFWKNDLGAIENYLNKTNWNHSVFDVPLHFNLYYASKSGGNYDMRQIFNGTVVQKHPTHAVTFVDNHDSQPEESLESFVREWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

SEQ ID NO: 5 - protein, 773 aa, Bacillus sp
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 6 - protein, 399 aa, Bacillus subtilis
ADLGHQTLESNDGWGAYSTGTTGGSKASSSHVYTVSNRNQLVSALGKPTNTTPKIIYIKGTIDFNVDDNLKPLGLNDYKDPEYDLDKYLKAYDPSTWGKKEPSGPLEEARARSQKNQKARVMVDIPANTTIVGSGTNAIIVGGNFHIKSDNVIIRNIEFQDAYDYFPQWDPTDGSSGNWNSQYDNITINGGTHIWIDHCTFNDGSRPDSTSPTYFGRPYQHHDGQTDASNGANYITMSYNYYHDHDKSSIFGSSDSKISDDGKLKITLHHNRYKNIVQRAPRVRFGQVHVYNNYYEGSTSSSDYPFSYAWGIGKSSKIYAQNNVIDVPGLPAAKTIKVFSGGTALYDSGTLLNGTQINASAANGLSSSVGWTPSLHGTIDASAHVKSNVISQAGAGKLN

SEQ ID NO: 7 - protein, 299 aa, Bacillus sp
ANSGFYVSGTTLYDANGNPFVMRGINHGHAWYKDQATTAIEGIANTGANTVRIVLSDGGQWTKDDIHTVRNLISLAEDNHLVAVLEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFQ

(19) United States
(12) Patent Application Publication
(10) Pub. No.: US 2019/0153356 A1
(43) Pub. Date: May 23, 2019

(54) Use of Enzymes, Detergent Composition and Laundry Method

(71) Applicant: Novozymes A/S, Bagsværd (DK)

(72) Inventor: Lillian Eva Tang BALTSEN, Bagsværd (DK)

(73) Assignee: Novozymes A/S, Bagsværd (DK)

(21) Appl. No.: 15/576,051

(22) PCT Filed: Jun. 23, 2016
(86) PCT No.: PCT/EP2016/064532

§ 371 Date: Nov. 21, 2017

(30) Foreign Application Priority Data
Jun. 24, 2015 (EP) 15173522.2

(51) Int. Cl. C11D 3/386; C11D 11/00; C11D 1/24

(52) U.S. Cl. CPC C11D 3/386; C11D 11/0017; C11D 3/38636; C11D 3/38627; C11D 3/38645; C11D 1/24

(57) ABSTRACT

The invention concerns the use of one or more enzymes for washing or rinsing a laudry item with water having a NaCl content of at least 0.05% at 20° C. and/or water having a BOD₅ value of at least above 3 mg O₂/L at 20° C. The invention further concerns a detergent composition and a laundering method.

### REFERENCE TO A SEQUENCE LISTING

This application contains a Sequence Listing in computer readable form, which is incorporated herein by reference.

### FIELD OF THE INVENTION

The invention concerns the use of one or more enzymes for washing or rinsing a laudry item with water having a salt content of at least 0.05% at 20° C. and/or a BOD value of at least 1 mg/L at 20° C. The invention further concerns a detergent composition for such use and a laundering method.

### BACKGROUND OF INVENTION

Water is a critical issue for the survival of all living organisms, as many organisms including the great majority of higher plants and most mammals must have access to fresh water to live. The water resources are limited and shortage of water already poses a problem in some areas. Due to the accelerated pace of population growth and an increase in the amount of water a single person uses, it is expected that this situation will continue to get worse. Many areas of the world are already experiencing stress on water availability. A shortage of water in the future would be detrimental to the human population as it would affect everything from sanitation, to overall health and the production of grain.

Also, there is an uneven distribution of fresh water. While some countries have an abundant supply of fresh water, others do not have as much. For example, Canada has 20% of the world's fresh water supply, while India has only 10% of the world's fresh water supply, even though India's population is more than 30 times larger than that of Canada. Thus, use of sea water and/or waste water may become important in the future.

Additionally, on drilling rigs, container wessels or bulk carriers fresh water is a limited source. Several attempts have been made on developing detergent compositions for use with seawater. GB2146323 describes a sodium alpha olefin sulphonate from fatty oil, which is a new soap for use in sea water. Rao B. S. and De C. P. recommend a specific detergent composition for use with sea water (Defence Science Journal, Vol. 6(1) 1956).

When laundry surfactants is used in hard water, the calcium and magnesium ions in the hard water react with the surfactant and form insoluble calcium and magnesium soaps, which have no detergency and no lathering property. Thus, a part of the surfactant is wasted when used in hard water and in order to get a cleaning effect, one have to dose even more soap.

### SUMMARY OF THE INVENTION

The present invention concerns the use of one or more enzymes for washing or rinsing a laundry item with water having a NaCl content of at least 0.05% at 20° C. and/or water having a BOD₅ value of at least above 3 mg O₂/L at 20° C. Further is claimed a detergent composition comprising an anionic surfactant, a builder and one or more enzymes selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and/or xanthanase, wherein the ratio between the anionic surfactant and the builder is in the range of 1:62.

Additionally, the invention concerns a method for laundering a textile comprising the steps of:
a. Contacting the textile with a wash liquor comprising a detergent compostion according to any of claims 17-44 and water having a NaCl content of at least 0.05% at 20° C. and/or water having a BOD5 value of at least above 3 mg O2/L at 20° C.;
b. Completing at least one wash cycle; and
c. Optionally rinsing the textile.

### Definitions

Biochemical oxygen demand or B.O.D is the biochemical oxygen demand. It refers to the amount of dissolved oxygen required by aerobic biological organisms to break down organic material in a water sample at a certain temperature over a specific period of time. BOD is often assessed over a period of 5 days and this value is then referred to as BOD₅. The BOD₅ value is often used as an indication of the degree of organic pollution of water systems.

BOD₅ values vary in different water systems depending on geological conditions and degree of pollution and thus it is difficult to give a general BOD₅ value for freshwater systems. The European Environmental Agency measured BOD₅ values at river stations across Europe in the 1990's and found values between 1.5 and 6 mg O₂/L (http://www.eea.europa.eu/data-and-maps/indicators/organic-matter-in-rivers/bod-and-ammonium-in-rivers). In general BOD₅ values less than 2 mg O₂/L are indicating clean rivers, whereas polluted rivers have BOD₅ values above 5 mg O₂/L.

The US EPA has developed a river pollution index including (RPI) BOD₅ value as a parameter (http://wq.epa.gov.tw/WQEPA/Code/Business/Standard.aspx?Languages=en). The BOD₅ values and dissolved oxygen values from US EPA river pollution index are shown in the table below.

TABLE
BOD₅ values as indication of water
pollution according to US EPA RPI.

| | Water Quality | | | |
|---|---|---|---|---|
| | Non- | Lightly- | Moderately- | Severely- |
| Item | polluted | polluted | polluted | polluted |
| Biochemical | BOD₅ ≤ | 3.0 < | 5.0 ≤ | BOD₅ > |
| Oxygen | 3.0 | BOD₅ ≤ | BOD₅ ≤ | 15.0 |
| Demand(BOD₅)mg/L | | 4.9 | 15.0 | |

According to US EPA a non-polluted river has a BOD₅ value below 3.0.

For comparison BOD₅ values for sewage or wastewater are above 100 mg O₂/L and often considerable higher.

Detergent Composition: The term “detergent composition” refers to compositions that find use in the removal of undesired compounds from items to be cleaned, such as textiles. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; fabric fresheners; fabric softeners; and textile and laundry pre-spotters/pretreatment). In addition to containing the enzyme of the invention, the detergent formulation may contain one or more additional enzymes (such as proteases, amylases, lipases, cutinases, cellulases, endoglucanases, xyloglucanases, pectinases, pectin lyases, xanthanases, peroxidases, haloperoxygenases, catalases and mannanases, or any mixture thereof), and/or detergent adjunct ingredients such as surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, transferase(s), hydrolytic enzymes, oxido reductases, bluing agents and fluorescent dyes, antioxidants, and solubilizers.

Enzyme Detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

Fragment: The term “fragment” means a polypeptide having one or more (e.g., several) amino acids absent from the amino and/or carboxyl terminus of a mature polypeptide or domain;

wherein the fragment has enzyme activity.

Fresh water: The term “fresh water” means water that is naturally occurring water on the Earth's surface in ice sheets, ice caps, glaciers, icebergs, bogs, ponds, lakes, rivers and streams, and underground as groundwater in aquifers and underground streams. Fresh water is generally characterized by having low concentrations of dissolved salts and other total dissolved solids. The term specifically excludes seawater, brackish water and water having a BOD₅ value above 3 mg O₂/L.

Improved wash performance: The term “improved wash performance” is defined herein as an enzyme displaying an increased wash performance in a detergent composition relative to the wash performance of same detergent composition without the enzyme e.g. by increased stain removal or less redeposition. The term “improved wash performance” includes wash performance in laundry.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide of the invention. The fermentation broth from that host cell will comprise the isolated polypeptide.

Laundering: The term “laundering” relates to both household laundering and industrial laundering and means the process of treating textiles with a solution containing a cleaning or detergent composition of the present invention. The laundering process can for example be carried out using e.g. a household or an industrial washing machine or can be carried out by hand. Remission value: Wash performance is expressed as a Remission value of the stained swatches. After washing and rinsing the swatches are spread out flat and allowed to air dry at room temperature overnight. All washes swatches are evaluated the day after the wash. Light reflectance evaluations of the swatches are done using a Macbeth Color Eye 7000 reflectance spectrophotometer with very small aperture. The measurements are made without UV in the incident light and remission at 460 nm is extracted.

Tap water: The term “tap water” means water having a quality so it can be used for human consumption.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and toweling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well.

Variant: The term “variant” means a polypeptide having same activity as the parent enzyme comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and enzyme optionally including a surfactant and further detergent ingredients.

### DETAILED DESCRIPTION OF THE INVENTION

The water resources are limited and shortage of water already poses a problem in some areas. Due to the accelerated pace of population growth and an increase in the amount of water a single person uses, it is expected that this situation will continue to get worse. Many areas of the world are already experiencing stress on water availability. A shortage of water in the future would be detrimental to the human population who will be forced to explore new ways of using water. One way could be replacing fresh water with salt water and/or waste water where possible. Additionally, on drilling rigs, container wessels or bulk carriers fresh water is a limited source.

Washing or rinsing of laundry items with salt water is common on drilling rigs or ships. However, washing with salt water can be problematic as the surfactant reacts with cations in the salt water and the washing effect of the surfactant is thereby reduced and one have to dose even more of the surfactant.

The inventor has suprisingly found that water having a NaCl content of at least 0.05% at 20° C. and/or water having a BOD₅ value of at least above 3 mg O₂/L at 20° C. can be used together with one or more enzymes for washing and/or rinsing laundry items with good washing result. The enzymes can be selected from the group consisting of proteases, lipases, cutinases, amylases, carbohydrases, cellulases, pectinases, mannanases, arabinases, galactanases, xylanases, peroxidases and oxidases. In one embodiment of the invention, the enzymes are a combination of protease, lipase and amylase. The inventor has found that the use of one or more enzymes inproves the wash performance when washing with water having a NaCl content of at least 0.05% at 20° C. and/or water having a BOD₅ value of at least above 3 mg O₂/L at 20° C. In one embodiment of the invention the enzyme is selected from the group consisting of protease, lipase, amylase, cellulase, pectate lyase and mannanase.

In one embodiment, the invention concerns a method for laundering a textile comprising the steps of:

a. Contacting the textile with a wash liquor comprising a detergent composition according to the invention and water having a NaCl content of at least 0.05% at 20° C. and/or water having a BOD5 value of at least above 3 mg O2/L at 20° C.;

b. Completing at least one wash cycle; and

c. Optionally rinsing the textile.

The concentration of the enzyme in the wash liquor is at least 0.01 g of enzyme protein per liter wash liquor, such as at least 0.015 g of enzyme protein, at least 0.02 g of enzyme protein, at least 0.025 g of enzyme protein, at least 0.03 g of enzyme protein per liter wash liquor.

The pH of the wash liquor is in the range of 1 to 11, such as in the range 5.5 to 11, such as in the range of 7 to 9, in the range of 7 to 8 or in the range of 7 to 8.5.

The wash liquor may have a temperature in the range of 5° C. to 95° C., or in the range of 10° C. to 80° C., in the range of 10° C. to 70° C., in the range of 10° C. to 60° C., in the range of 10° C. to 50° C., in the range of 15° C. to 40° C. or in the range of 20° C. to 30° C. In one embodiment the temperature of the wash liquor is 30° C.

In one embodiment, the method further comprises draining of the wash liquor or part of the wash liquor after completion of a wash cycle. The laundering process may comprise contacting the item to a wash liquor during a first and optionally a second or a third wash cycle. In one embodiment the item is rinsed after being contacted to the wash liquor. The item can be rinsed with water water having a salt content at 20° C. of at least 0.05% and/or a BOD value of at least 1 mg/L at 20° C., where the water optionally comprises a conditioner.

In one embodiment, the item is rinsed with salt water or with salt water comprising a conditioner. In one embodiment, the item is rinsed with a combination of salt water and water having a BOD₅ value of at least above 3 mg O₂/L at 20° C. In one embodiment, the item is rinsed with fresh water or a combination of fresh water, salt water and water having a BOD₅ value of at least above 3 mg O₂/L at 20° C.

In one embodiment, the water used is sea water. The salt content of sea water varies and depends on the ocean. The ocean is about 3% salt, the salt content of the Atlantic Sea is 3.5%, whereas the salt content of sea water present in fjords or near river outlets the salt content is lower. In one embodiment of the invention the water is waste water. The waste water can be from domestic house hold, institutions or from industry. The waste water does not include waste water from industrial laundering processes.

In one embodiment, the water is diluted with fresh water to obtain a lower content of NaCl and/or a lower BOD5 value. The water can be sea water.

In one embodiment of the invention, the sea water is diluted with fresh water so that the salt content of the water is lowered. In one embodiment of the invention the sea water is diluted to obtain a salt content below 3% salt. In one embodiment the sea water is diluted to a salt content below 2.5%, below 2% or below 1.5%

In one embodiment, the water used is water having a BOD₅ value in the range of 3 mg O₂/L at 20° C. to 100 mg O₂/L at 20° C. The BOD₅ value of waste water varies and depends on the treatment of the waste water. In one embodiment of the invention the water has or is diluted to have a BOD₅ value at 20° C. in the range of 5 to 100 mg O₂/L, in the range of 10 to 100 mg O₂/L, in the range of 20 to 100 mg O₂/L, in the range of 30 to 100 mg O₂/L, in the range of 40 to 100 mg O₂/L, in the range of 50 to 100 mg O₂/L, in the range of 60 to 100 mg O₂/L,in the range of 70 to 100 mg O₂/L, in the range of 80 to 100 mg O₂/L or in the range of 90 to 100 mg O₂/L.

In one embodiment of the invention, the water has or is diluted to have a BOD₅ value at 20° C. in the range of 3 to 20 mg O₂/L, in the range of 3 to 15 mg O₂/L, in the range of 3 to 10 mg O₂/L, in the range of 3 to 8 mg O₂/L, in the range of 3 to 6 mg 02/L, in the range of 4 to 20 mg O₂/L, in the range of 4 to 15 mg O₂/L, in the range of 4 to 10 mg O₂/L, in the range of 4 to 8 mg O₂/L, in the range of 4 to 6 mg O₂/L, in the range of 5 to 20 mg O₂/L, in the range of 5 to 15 mg O₂/L, in the range of 5 to 10 mg O₂/L, in the range of 5 to 8 mg O₂/L, in the range of 5 to 6 mg O₂/L, in the range of 6 to 20 mg O₂/L, in the range of 6 to 15 mg O₂/L, in the range of 6 to 10 mg O₂/L, in the range of 6 to 8 mg O₂/L, in the range of 8 to 20 mg O₂/L, in the range of 8 to 15 mg O₂/L, in the range of 8 to 10 mg O₂/L, in the range of 10 to 20 mg O₂/L or in the range of 10 to 15 mg O₂/L.

In one embodiment of the invention, the water has or is diluted to have a NaCl content in the water at 20° C. of at least 0.1%, such as at least 0.2%, at least 0.3%, at least 0.4%, at least 0.5%, at least 0.6%, at least 0.7%, at least 0.8%, at least 0.9%, at least 1.0%, at least 1.1%, at least 1.2%, at least 1.3%, at least 1.4%, at least 1.5%, at least 1.6%, at least 1.7%, at least 1.8%, at least 1.9%, at least 2.0%, at least 2.2%,at least 2.4%,at least 2.6%,at least 2.8%, at least 3.0%, at least 3.2%, at least 3.4%, at least 3.5%, at least 3.6%, at least 3.8%, at least 4.0%, at least 4.5%, at least 5.0%.

In one embodiment of the invention, the water has or is diluted to have a NaCl content in the water at 20° C. in the range of 0.05% to 10%.

In one embodiment of the invention, the water is diluted to obtain a NaCl content below 2% and/or a BOD₅ value below 20.

In one embodiment, the NaCl content of the water at 20° C. is in the range of 0.05% to 9%, in the range of 0.05% to 8%, in the range of 0.05% to 7%, in the range of 0.05% to 7%, in the range of 0.05% to 6%, in the range of 0.05% to 5%, in the range of 0.05% to 4%, in the range of 0.05% to 3.8%, in the range of 0.05% to 3.6%, in the range of 0.05% to 3.5% or in the range of 0.05% to 3.3%.

In one embodiment, the NaCl content of the water at 20° C. is in the range of 0.1% to 9%, in the range of 0.1% to 8%, in the range of 0.1% to 7%, in the range of 0.1% to 7%, in the range of 0.1% to 6%, in the range of 0.1% to 5%, in the range of 0.1% to 4%, in the range of 0.1% to 3.8%, in the range of 0.1% to 3.6%, in the range of 0.1% to 3.5% or in the range of 0.1% to 3.3%.

In one embodiment, the NaCl content of the water at 20° C. is in the range of 0.2% to 9%, in the range of 0.2% to 8%, in the range of 0.2% to 7%, in the range of 0.2% to 7%, in the range of 0.2% to 6%, in the range of 0.2% to 5%, in the range of 0.2% to 4%, in the range of 0.2% to 3.8%, in the range of 0.2% to 3.6%, in the range of 0.2% to 3.5% or in the range of 0.2% to 3.3%.

In one embodiment, the NaCl content of the water at 20° C. is in the range of 0.3% to 9%, in the range of 0.3% to 8%, in the range of 0.3% to 7%, in the range of 0.3% to 7%, in the range of 0.3% to 6%, in the range of 0.3% to 5%, in the range of 0.3% to 4%, in the range of 0.3% to 3.8%, in the range of 0.3% to 3.6%, in the range of 0.3% to 3.5% or in the range of 0.3% to 3.3%.

In one embodiment, the NaCl content of the water at 20° C. is in the range of 0.4% to 9%, in the range of 0.4% to 8%, in the range of 0.4% to 7%, in the range of 0.4% to 7%, in the range of 0.4% to 6%, in the range of 0.4% to 5%, in the range of 0.4% to 4%, in the range of 0.4% to 3.8%, in the range of 0.4% to 3.6%, in the range of 0.4% to 3.5% or in the range of 0.4% to 3.3%.

In one embodiment, the NaCl content of the water at 20° C. is in the range of 0.5% to 9%, in the range of 0.5% to 8%, in the range of 0.5% to 7%, in the range of 0.5% to 7%, in the range of 0.5% to 6%, in the range of 0.5% to 5%, in the range of 0.5% to 4%, in the range of 0.5% to 3.8%, in the range of 0.5% to 3.6%, in the range of 0.5% to 3.5% or in the range of 0.5% to 3.3%.

In one embodiment, the NaCl content of the water at 20° C. is in the range of 1% to 9%, in the range of 1% to 8%, in the range of 1% to 7%, in the range of 1% to 7%, in the range of 1% to 6%, in the range of 1% to 5%, in the range of 1% to 4%, in the range of 1% to 3.8%, in the range of 1% to 3.6%, in the range of 1% to 3.5% or in the range of 1% to 3.3%.

In one embodiment, the NaCl content of the water at 20° C. is in the range of 2% to 9%, in the range of 2% to 8%, in the range of 2% to 7%, in the range of 2% to 7%, in the range of 2% to 6%, in the range of 2% to 5%, in the range of 2% to 4%, in the range of 2% to 3.8%, in the range of 2% to 3.6%, in the range of 2% to 3.5% or in the range of 2% to 3.3%.

In one embodiment, the NaCl content of the water at 20° C. is in the range of 3% to 9%, in the range of 3% to 8%, in the range of 3% to 7%, in the range of 3% to 7%, in the range of 3% to 6%, in the range of 3% to 5%, in the range of 3% to 4%, in the range of 3% to 3.8%, in the range of 3% to 3.6%, in the range of 3% to 3.5% or in the range of 3% to 3.3%.

In one embodiment, the NaCl content of the water at 20° C. is in the range of 3.5% to 9%, in the range of 3.5% to 8%, in the range of 3.5% to 7%, in the range of 3.5% to 7%, in the range of 3.5% to 6%, in the range of 3.5% to 5% or in the range of 3.5% to 4.

In one embodiment, the invention further comprises the use of at least one anionic surfactant and at least one builder is used in addition to the one or more enzymes. The the ratio between the anionic surfactant and the builder should be about 1:62. In one embodiment of the invention the ratio between the anionic surfactant and the builder is in the range of 1:20 to 1:62.

In one embodiment, the invention concerns a detergent composition comprising an anionic surfactant, a builder and one or more enzymes selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and/or xanthanase, wherein the ratio between the anionic surfactant and the builder is in the range of 1:62. In one embodiment of the invention the ratio between the anionic surfactant and the builder is in the range of 1:20 to 1:62.

The anionic surfactant can be selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS), sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid and salt of fatty acids (soap). In a preferred embodiment the anionic surfactant is LAS.

The detergent composition may contain about 0-65% by weight, such as about 5% to about 50% of a detergent builder or co-builder, or a mixture thereof. The builder and/or co-builder may particularly be a chelating agent that forms water-soluble complexes with Ca and Mg. Any builder and/or co-builder known in the art for use in detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PH DA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

In a preferred embodiment, the one or more enzymes in the detergent composition can be selected from the group consisting of protease, lipase, amylase, cellulase, pectate lyase and mannanase.

The protease may be selected from the group consisting of Bacillus, e.g., subtilisin Novo, subtilisin Carlsberg, subtilisin 309, subtilisin 147, subtilisin 168, trypsin of bovine origin, trypsin of porcine origin and Fusarium protease.

In one embodiment of the invention, the protease has at least 90%, such as at least 95%, sequence identity to SEQ ID NO: 1. In one embodiment, the protease has at least 90% identity to the amino acid sequence of SEQ ID NO: 1 or a variant thereof with substitutions in one or more of the following positions: 27, 36, 57, 76, 87, 97, 101, 104, 120, 123, 167, 170, 194, 206, 218, 222, 224, 235, and 274, preferably the variant is an alkaline protease having at least 90% identity to the amino acid sequence of SEQ ID NO: 1 with the following substitution: M222S or substitutions N76D+G195E.

In one embodiment of the invention, the lipase is a polypeptide having at least 90%, such as at least 95%, sequence identity to SEQ ID NO: 2 or a variant thereof wherein the polypeptide comprises the following substitutions T231R and N233R.

In one embodiment of the invention, the amylase is an alpha-amylase having at least 90% identity to the amino acid sequence of SEQ ID NO: 3 10 or SEQ ID NO: 4 or a variant thereof.

In one embodiment of the invention, the enzyme is a cellulase, wherein the cellulase is an alkaline bacterial enzyme exhibiting endo-beta-1,4-glucanase activity (E.C. 3.2.1.4). The cellulase may be a polypeptide having at least 90%, such as at least 95% or 100% sequence identity to SEQ ID NO: 5 or a variant thereof.

In one embodiment of the invention, the enzyme has pectate lyase activity and may be a polypeptide having at least 90%, such as at least 95% or 100% sequence identity to SEQ ID NO: 6 or a variant thereof.

In one embodiment of the invention, the enzyme is mannanase such as a polypeptide having at least 90%, such as at least 95% or 100% sequence identity to SEQ ID NO: 7 or a variant thereof.

The detergent composition can comprise one of the ingredients selected from the group consisting of surfactants, builders, flocculating aid, chelating agents, dye transfer inhibitors, enzymes, enzyme stabilizers, enzyme inhinitors, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, builders and co-builders, fabric huing agents, anti-foaming agents, dispersants, processing aids, and/or pigments.

In one embodiment of the invention, the concentration of the enzyme in the detergent composition is at least 3,7×10-7 g enzyme protein per gram detergent composition, at least 4.0×10-7 g enzyme protein per gram detergent composition, at least 4.5×10-7 g enzyme protein per gram detergent composition, at least 5×10-7 g enzyme protein per gram detergent composition or at least 6.0×10-7 g enzyme protein per gram detergent composition.

The detergent composition may be formulated as a bar, a homogenous tablet, a tablet having two or more layers, a pouch having one or more compartments, a regular or compact powder, a granule, a paste, a gel, or a regular, compact or concentrated liquid.

The invention futher concerns a liquid detergent composition comprising a surfactant and a detergent and a detergent builder in a total concentration of at least 3% by weight, and an enzyme containing microcapsule, wherein the membrane of the microcapsule is produced by cross-linking of a polybranched polyamine having a molecular weight of more than 1 kDa. The inventors have found, that encapsulating enzymes in a microcapsule with a semipermeable membrane of the invention, and having a water activity inside these capsules (prior to addition to the liquid detergent) higher than in the liquid detergent, the capsules will undergo a (partly) collapse when added to the detergent (water is oozing out), thus leaving a more concentrated and more viscous enzyme containing interior in the capsules. The collapse of the membrane may also result in a reduced permeability. This can be further utilized by addition of stabilizers/polymers, especially ones that are not permeable through the membrane. The collapse and resulting increase in viscosity will reduce/hinder the diffusion of hostile components (e.g., surfactants or sequestrants) into the capsules, and thus increase the storage stability of the enzyme in the liquid detergent. Components in the liquid detergent that are sensitive to the enzyme (e.g., components that act as substrate for the enzyme) are also protected against degradation by the enzyme. During wash the liquid detergent is diluted by water, thus increasing the water activity. Water will now diffuse into the capsules (osmosis). The capsules will swell and the membrane will either become permeable to the enzyme so they can leave the capsules, or simply burst and in this way releasing the enzyme. The concept is very efficient in stabilizing the enzymes against hostile components in liquid detergent, and vice versa also protects enzyme sensitive components in the liquid detergent from enzymes. The microcapsule can be produced as described in WO 2014/177709.

### Detergent Compositions

In one embodiment, the invention is directed to detergent compositions comprising an enzyme of the present invention in combination with one or more additional cleaning composition components. The choice of additional components is within the skill of the artisan and includes conventional ingredients, including the exemplary non-limiting components set forth below.

### Liquid Detergent Composition

The liquid detergent composition may comprise a microcapsule of the invention, and thus form part of, any detergent composition in any form, such as liquid and powder detergents, and soap and detergent bars.

In one embodiment, the invention is directed to liquid detergent compositions comprising a microcapsule, as described above, in combination with one or more additional cleaning composition components.

The microcapsule, as described above, may be added to the liquid detergent composition in an amount corresponding to from 0.0001% to 5% (w/w) active enzyme protein (AEP); preferably from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

The liquid detergent composition has a physical form, which is not solid (or gas). It may be a pourable liquid, a paste, a pourable gel or a non-pourable gel. It may be either isotropic or structured, preferably isotropic. It may be a formulation useful for washing in automatic washing machines or for hand washing. It may also be a personal care product, such as a shampoo, toothpaste, or a hand soap.

The liquid detergent composition may be aqueous, typically containing at least 20% by weight and up to 95% water, such as up to 70% water, up to 50% water, up to 40% water, up to 30% water, or up to 20% water. Other types of liquids, including without limitation, alkanols, amines, diols, ethers and polyols may be included in an aqueous liquid detergent. An aqueous liquid detergent may contain from 0-30% organic solvent. A liquid detergent may even be non-aqueous, wherein the water content is below 10%, preferably below 5%.

Detergent ingredients can be separated physically from each other by compartments in water dissolvable pouches. Thereby negative storage interaction between components can be avoided. Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry. A detergent unit dose product is the packaging (e.g., in a pouch made from a water soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids (see e.g., US 2009/0011970).

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

The choice of additional components is within the skill of the artisan and includes conventional ingredients, including the exemplary non-limiting components set forth below.

### Enzymes

The detergent additive as well as the detergent composition may comprise one or more additional enzymes such as a protease, lipase, cutinase, an amylase, carbohydrase, cellulase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat . No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and WO99/001544.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Celluzyme™, and Carezyme™ (Novozymes A/S) Carezyme Premium™ (Novozymes A/S), Celluclean™ (Novozymes A/S), Celluclean Classic™ (Novozymes A/S), Cellusoft™ (Novozymes A/S), Whitezyme™ (Novozymes A/S), Clazinase™, and Puradax HA™ (Genencor International Inc.), and KAC-500(B)™ (Kao Corporation).

### Proteases

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those obtained from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN', subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases obtained from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those obtained from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V4I, S9R, A15T, K27R, *36D, V68A, N76D, N87S,R, *97E, A98S, S99G,D,A, S99AD, S101G,M,R S103A, V104I, Y,N, S106A, G118V,R, H120D,N, N123S, S128L, P129Q, S130A, G160D, Y167A, R170S, A194P, G195E, V199M, V205I , L217D, N218D, M222S, A232V, K235L, Q236H, Q245R, N252K, T274A (using BPN′ numbering).

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes A/S), those sold under the tradename Maxatase®, Maxacal®, Maxapem®, Purafect®, Purafect Prime®, Preferenz™, Purafect MA®, Purafect Ox®, Purafect OxP®, Puramax®, Properase®, Effectenz™, FN2®, FN3®, FN4®, Excellase®, Opticlean® and Optimase® (Danisco/DuPont), Axapem™ (Gist-Brocases N. V.), BLAP (sequence shown in FIG. 29 of U.S. Pat. No. 5,352,604) and variants hereof (Henkel A G) and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases which can be used together with the enzyme of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase obtained from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase obtained from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T49I+G107A+H156Y+A181T+N190F+I201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K, wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme PIus™, Natalase™, Liquozyme X and BAN™ (from Novozymes A/S), and Rapidase™ Purastar™/Effectenz™, Powerase and Preferenz S100 (from Genencor International Inc./DuPont).

### Peroxidases/Oxidases

A peroxidase according to the invention is a peroxidase enzyme comprised by the enzyme classification EC 1.11.1.7, as set out by the Nomenclature Committee of the International Union of Biochemistry and Molecular Biology (IUBMB), or any fragment obtained therefrom, exhibiting peroxidase activity.

Suitable peroxidases include those of plant, bacterial or fungal origin. Chemically modified or protein engineered mutants are included. Examples of useful peroxidases include peroxidases from Coprinopsis, e.g., from C. cinerea (EP 179,486), and variants thereof as those described in WO 93/24618, WO 95/10602, and WO 98/15257.

A peroxidase according to the invention also includes a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions.

In an embodiment, the haloperoxidase of the invention is a chloroperoxidase. Preferably, the haloperoxidase is a vanadium haloperoxidase, i.e., a vanadate-containing haloperoxidase. In a preferred method of the present invention the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In a preferred embodiment, the haloperoxidase is derivable from Curvularia sp., in particular Curvularia verruculosa or Curvularia inaequalis, such as C. inaequalis CBS 102.42 as described in WO 95/27046; or C. verrucuosa CBS 147.63 or C. verrucu/osa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Genicu/osporium sp. as described in WO 01/79460.

An oxidase according to the invention include, in particular, any laccase enzyme comprised by the enzyme classification EC 1.10.3.2, or any fragment obtained therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be obtained from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phiebia, e.g., P. radiata (WO 92/01046), or Coriolus, e.g., C. hirsutus (JP 2238885).

Suitable examples from bacteria include a laccase derivable from a strain of Bacillus.

A laccase obtained from Coprinopsis or Myceliophthora is preferred; in particular a laccase obtained from Coprinopsis cinerea, as disclosed in WO 97/08325; or from Myceliophthora thermophila, as disclosed in WO 95/33836.

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent , which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

### Laundry Soap Bars

The enzymes may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, optionally one or more additional enzymes, a protease inhibitor, and a salt of a monovalent cation and an organic anion may be prepared and and the mixture is then plodded. The additional enzymes may be added at the same time as the protease inhibitor for example in liquid form. Besides the mixing step and the plodding step, the process may further comprise the steps of milling, extruding, cutting, stamping, cooling and/or wrapping.

### Formulation of Enzyme in Co-Granule

The enzymes may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates are disclosed in WO 2013/188331, which relates to a detergent composition comprising (a) a multi-enzyme co-granule; (b) less than 10 wt zeolite (anhydrous basis); and (c) less than 10 wt phosphate salt (anhydrous basis), wherein said enzyme co-granule comprises from 10 to 98 wt % moisture sink component and the composition additionally comprises from 20 to 80 wt % detergent moisture sink component. WO 2013/188331 also relates to a method of treating and/or cleaning a surface, preferably a fabric surface comprising the steps of (i) contacting said surface with the detergent composition as claimed and described herein in an aqueous wash liquor, (ii) rinsing and/or drying the surface.

The multi-enzyme co-granule may comprise two or more enzymes selected from the group consisting of first-wash lipases, cleaning cellulases, xyloglucanases, perhydrolases, peroxidases, lipoxygenases, laccases and mixtures thereof; and (b) one or more enzymes selected from the group consisting of hemicellulases, proteases, care cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, and mixtures thereof.

The invention is further summarized in the following paragraphs:
1. Use of one or more enzymes for washing or rinsing a laundry item with water having a NaCl content of at least 0.05% at 20° C. and/or water having a BOD₅ value of at least above 3 mg O₂/L at 20° C.
2. Use according to paragraph 1, wherein the enzymes is selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and xanthanase.
3. Use according to any of the preceding paragraphs, wherein the enzymes is selected from the group of protease, lipase, amylase, cellulase, pectate lyase and mannanase.
4. Use according to any of the preceding paragraphs, wherein the water is sea water.
5. Use according to any of the preceding paragraphs, wherein the water is waste water from domestic house hold, institutions or industry.
6. Use according to any of the preceding paragraphs, wherein the water has a BOD₅ value in the range of 3 mg O₂/L at 20° C. to 100 mg O₂/L at 20° C.
7. Use according to any of the preceding paragraphs, wherein the water has a BOD₅ value at 20° C. in the range of 5 to 100 mg O₂/L, in the range of 10 to 100 mg O₂/L, in the range of 20 to 100 mg O₂/L, in the range of 30 to 100 mg O₂/L, in the range of 40 to 100 mg O₂/L, in the range of 50 to 100 mg O₂/L, in the range of 60 to 100 mg O₂/L,in the range of 70 to 100 mg O₂/L, in the range of 80 to 100 mg O₂/L or in the range of 90 to 100 mg O₂/L.
8. Use according to any of paragraphs 1-6, wherein the water has a BOD₅ value at 20° C. in the range of 3 to 20 mg O₂/L, in the range of 3 to 15 mg O₂/L, in the range of 3 to 10 mg O₂/L, in the range of 3 to 8 mg O₂/L, in the range of 3 to 6 mg 02/L, in the range of 4 to 20 mg O₂/L, in the range of 4 to 15 mg O₂/L, in the range of 4 to 10 mg O₂/L, in the range of 4 to 8 mg O₂/L, in the range of 4 to 6 mg O₂/L, in the range of 5 to 20 mg O₂/L, in the range of 5 to 15 mg O₂/L, in the range of 5 to 10 mg O₂/L, in the range of 5 to 8 mg O₂/L, in the range of 5 to 6 mg O₂/L, in the range of 6 to 20 mg O₂/L, in the range of 6 to 15 mg O₂/L, in the range of 6 to 10 mg O₂/L, in the range of 6 to 8 mg O₂/L, in the range of 8 to 20 mg O₂/L, in the range of 8 to 15 mg O₂/L, in the range of 8 to 10 mg O₂/L, in the range of 10 to 20 mg O₂/L or in the range of 10 to 15 mg O₂/L.
9. Use according to any of the preceding paragraphs, wherein the NaCl content of the water at 20° C. is at least 0.1%, such as at least 0.2%, at least 0.3%, at least 0.4%, at least 0.5%, at least 0.6%, at least 0.7%, at least 0.8%, at least 0.9%, at least 1.0%, at least 1.1%, at least 1.2%, at least 1.3%, at least 1.4%, at least 1.5%, at least 1.6%, at least 1.7%, at least 1.8%, at least 1.9%, at least 2.0%, at least 2.2%,at least 2.4%,at least 2.6%,at least 2.8%, at least 3.0%, at least 3.2%, at least 3.4%, at least 3.5%, at least 3.6%, at least 3.8%, at least 4.0%, at least 4.5%, at least 5.0%.
10. Use according to any of paragraphs 1-8, wherein the NaCl content of the water at 20° C. is in the range of 0.05% to 10%.
11. Use according to any of the preceding paragraphs, wherein the water is diluted with fresh water to obtain a lower content of NaCl and/or a lower BOD₅ value.
12. Use according to paragraph 11, wherein the water is diluted to obtain a NaCl content below 2% and/or a BOD₅ value below 20.
13. Use according to any of the preceding paragraphs, wherein at least one anionic surfactant and at least one builder is used in addition to the one or more enzymes.
14. Use according to paragraph 13, wherein the ratio between the anionic surfactant and the builder is 1:62.
15. Use according to any of the paragraphs 13-14, wherein the anionic surfactant is selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS), sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid and salt of fatty acids (soap).
16. A detergent composition comprising an anionic surfactant, a builder and one or more enzymes selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and/or xanthanase, wherein the ratio between the anionic surfactant and the builder is in the range of 1:62.
17. Detergent composition according to paragraph 16, wherein the ratio between the anionic surfactant and the builder is in the range of 1:20 to 1:62.
18. Detergent composition according to any of paragraphs 16-17, wherein the one or more enzymes are selected from the group consisting of protease, lipase, amylase, cellulase, pectate lyase and mannanase.
19. Detergent composition according to any of paragraphs 16-18, wherein the protease is selected from the group consisting of Bacillus, e.g., subtilisin Novo, subtilisin Carlsberg, subtilisin 309, subtilisin 147, subtilisin 168, trypsin of bovine origin, trypsin of porcine origin and Fusarium protease.
20. Detergent composition according to any of paragraphs 16-19, wherein the protease has at least 90%, such as at least 95% or 100% sequence identity to SEQ ID NO: 1.
21. Detergent composition according to any of paragraphs 19-20, wherein the protease has at least 90% such as at least 95% or 100% identity to the amino acid sequence of SEQ ID NO: 1 or a variant thereof with substitutions in one or more of the following positions: 27, 36, 57, 76, 87, 97, 101, 104, 120, 123, 167, 170, 194, 206, 218, 222, 224, 235, and 274, preferably the variant is an alkaline protease having at least 90% identity to the amino acid sequence of SEQ ID NO: 1 with the following substitution: M222S or substitutions N76D+G195E.
22. Detergent composition according to paragraph 18, wherein the lipase is a polypeptide having at least 90%, such as at least 95% or 100% sequence identity to SEQ ID NO: 2 or a variant thereof.
23. Detergent composition according to paragraph 18, wherein the alpha-amylase has at least 90% identity, such as at least 95% or 100% sequence identity to the amino acid sequence of SEQ ID NO: 3 or SEQ ID NO: 4 or a variant thereof.
24. Detergent composition according to paragraph 18, wherein the cellulase is an alkaline bacterial enzyme exhibiting endo-beta-1,4-glucanase activity (E.C. 3.2.1.4).
25. Detergent composition according to paragraph 24, wherein the cellulase is a polypeptide having at least 90%, such as at least 95% or 100% sequence identity to SEQ ID NO: 5 or a variant thereof.
26. Detergent composition according to any of paragraphs 16-18, wherein the pectate lyase is a polypeptide having at least 90%, such as at least 95% or 100% sequence identity to SEQ ID NO: 6 or a variant thereof.
27. Detergent composition according to paragraph 18, wherein the mannanase is polypeptide having at least 90%, such as at least 95% or 100% sequence identity to SEQ ID NO: 7 or a variant thereof.
28. Detergent composition according to any of the preceding composition paragraphs, wherein the detergent composition further comprises one oe more ingredients selected from the group consisting of surfactants, builders and co-builders, flocculating aid, chelating agents, dye transfer inhibitors, stabilizers, enzyme inhinitors, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, fabric huing agents, anti-foaming agents, dispersants, processing aids, and/or pigments.
29. Detergent composition according to any of the preceding composition paragraphs, wherein the anionic surfactant is selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS), sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid and salt of fatty acids (soap).
30. Detergent composition according to paragraph 29, wherein the anionic surfactant is LAS.
31. Detergent composition according to any of the preceding composition paragraphs, wherein the concentration of the enzyme is at least 3.7×10⁻⁷ g enzyme protein per gram detergent composition, at least 4.0×10⁻⁷ g enzyme protein per gram detergent composition, at least 4.5×10⁻⁷ g enzyme protein per gram detergent composition, at least 5×10⁻⁷ g enzyme protein per gram detergent composition or at least 6.0×10⁻⁷ g enzyme protein per gram detergent composition.
32. Detergent composition according to any of the preceding composition paragraphs, wherein the composition is a bar, a homogenous tablet, a tablet having two or more layers, a pouch having one or more compartments, a regular or compact powder, a granule, a paste, a gel, or a regular, compact or concentrated liquid.
33. Detergent composition according to paragraph 32, wherein the composition is a liquid detergent composition, comprising a surfactant and a builder in a total concentration of at least 3% by weight, and an enzyme containing microcapsule, wherein the membrane of the microcapsule is produced by cross-linking of a polybranched polyamine having a molecular weight of more than 1 kDa.
34. Detergent composition according to paragraph 33, wherein the reactive amino groups of the polybranched polyamine constitute at least 15% of the molecular weight.
35. Detergent composition according to any of paragraphs 33-34, wherein the microcapsule is produced by using an acid chloride as crosslinking agent.
36. Detergent composition according to any of paragraphs 33-35, wherein the diameter of the microcapsule is at least, or above, 50 micrometers.
37. Detergent composition according to any of paragraphs 33-36, wherein the microcapsule contains at least 1% by weight of active enzyme.
38. Detergent composition according to any of paragraphs 33-37, which further includes an alcohol, such as a polyol.
39. Detergent composition according to any of paragraphs 33-38, which is a liquid laundry detergent composition.
40. Detergent composition according to any of paragraphs 33-39, which contains less than 90% by weight of water.
41. Detergent composition according to any of paragraphs 33-40, wherein the microcapsule is produced by interfacial polymerization using an acid chloride as crosslinking agent.
42. Detergent composition according to any of paragraphs 33-41, wherein the polybranched polyamine is a polyethyleneimine.
43. Detergent composition according to any of paragraphs 33-42, wherein the microcapsule comprises a source of Mg2+, Ca2+, or Zn2+ ions, such as a poorly soluble salt of Mg2+, Ca2+, or Zn2+.
44. A method for laundering a textile comprising the steps of:
   a. Contacting the textile with a wash liquor comprising a detergent composition according to any of paragraphs 16-43 and water having a NaCl content of at least 0.05% at 20° C. and/or water having a BOD₅ value of at least above 3 mg O₂/L at 20° C.
   b. Completing at least one wash cycle; and
   c. Optionally rinsing the textile.
45. Method according to paragraph 44, wherein the water is sea water.
46. Method according to any of the preceding method paragraphs, wherein the water has a BOD₅ value in the range of 3 mg O₂/L at 20° C. to 100 mg O₂/L at 20° C.
47. Method according to any of the preceding method paragraphs, wherein the water has a BOD₅ value at 20° C. in the range of 5 to 100 mg O₂/L, in the range of 10 to 100 mg O₂/L, in the range of 20 to 100 mg O₂/L, in the range of 30 to 100 mg O₂/L, in the range of 40 to 100 mg O₂/L, in the range of 50 to 100 mg O₂/L, in the range of 60 to 100 mg O₂/L,in the range of 70 to 100 mg O₂/L, in the range of 80 to 100 mg O₂/L or in the range of 90 to 100 mg O₂/L.
48. Method according to any of the preceding method paragraphs, wherein the water has a BOD₅ value at 20° C. in the range of 3 to 20 mg O₂/L, in the range of 3 to 15 mg O₂/L, in the range of 3 to 10 mg O₂/L, in the range of 3 to 8 mg O₂/L, in the range of 3 to 6 mg O₂/L, in the range of 4 to 20 mg O₂/L, in the range of 4 to 15 mg O₂/L, in the range of 4 to 10 mg O₂/L, in the range of 4 to 8 mg O₂/L, in the range of 4 to 6 mg O₂/L, in the range of 5 to 20 mg O₂/L, in the range of 5 to 15 mg O₂/L, in the range of 5 to 10 mg O₂/L, in the range of 5 to 8 mg O₂/L, in the range of 5 to 6 mg O₂/L, in the range of 6 to 20 mg O₂/L, in the range of 6 to 15 mg O₂/L, in the range of 6 to 10 mg O₂/L, in the range of 6 to 8 mg O₂/L, in the range of 8 to 20 mg O₂/L, in the range of 8 to 15 mg O₂/L, in the range of 8 to 10 mg O₂/L, in the range of 10 to 20 mg O₂/L or in the range of 10 to 15 mg O₂/L.
49. Method according to any of the preceding method paragraphs, wherein the NaCl content of the water at 20° C. is at least 0.1%, such as at least 0.2%, at least 0.3%, at least 0.4%, at least 0.5%, at least 0.6%, at least 0.7%, at least 0.8%, at least 0.9%, at least 1.0%, at least 1.1%, at least 1.2%, at least 1.3%, at least 1.4%, at least 1.5%, at least 1.6%, at least 1.7%, at least 1.8%, at least 1.9%, at least 2.0%, at least 2.2%,at least 2.4%,at least 2.6%,at least 2.8%, at least 3.0%, at least 3.2%, at least 3.4%, at least 3.5%, at least 3.6%, at least 3.8%, at least 4.0%, at least 4.5%, at least 5.0%.
50. Method according to any of the preceding method paragraphs, wherein the NaCl content of the water at 20° C. is in the range of 0.05% to 10%.
51. Method according to any of the preceding method paragraphs, wherein the water is diluted with fresh water to obtain a lower content of NaCl and/or a lower BOD₅ value.
52. Method according to paragraph 51, wherein the water is diluted to obtain a NaCl content below 2% at 20° C. and/or a BOD₅ value below 20 mg O₂/L at 20° C.
53. Method according to any of the preceding method paragraphs, wherein the concentration of the one or more enzyme in the wash liquor is at least 0.01 g of enzyme protein per liter wash liquor, such as at least 0.015 g of enzyme protein, at least 0.02 g of enzyme protein, at least 0.025 g of enzyme protein, at least 0.03 g of enzyme protein per liter wash liquor.
54. Method according to any of the preceding method paragraphs, wherein the method further comprises draining of the wash liquor or part of the wash liquor after completion of a wash cycle.
55. Method according to any of the preceding method paragraphs, wherein the textile is contacted with the wash liquor during a first and optionally a second or a third wash cycle.
56. Method according to any of the preceding method paragraphs, wherein the textile is rinsed after being contacted with the wash liquor.
57. Method according to any of the preceding method paragraphs, wherein the item is rinsed with water having a NaCl content of at least 0.05% at 20° C. and/or water having a BOD₅ value of at least above 3 mg O₂/L at 20° C.
58. Method according to paragraph 56, wherein the textile is rinsed fresh water
59. Method according to paragraph 56, wherein the water for rinsing is a combination of fresh water and water having a NaCl content at 20° C. of at least 0.05% and/or water having a BOD₅ value of at least above 3 mg O₂/L at 20° C.

### Assays and Detergent Compositions

### Detergent Compositions

The below mentioned detergent composition can be used in combination with the enzyme of the invention.

### Biotex Black (Liquid)

5-15% Anionic surfactants, <5% Nonionic surfactants, perfume, enzymes, DMDM and hydantoin.

### Composition of WFK IEC-A Model Detergent (Powder)

Ingredients: Linear sodium alkyl benzene sulfonate 8.8%, Ethoxylated fatty alcohol C12-18 (7 EO) 4.7%, Sodium soap 3.2%, Anti foam DC2-42485 3.9%, Sodium aluminium silicate zeolite 4A 28.3%, Sodium carbonate 11.6%, Sodium salt of a copolymer from acrylic and maleic acid (Sokalan CP5) 2.4%, Sodium silicate 3.0%, Carboxymethylcellulose 1.2%, Dequest 2066 2.8%, Optical whitener 0.2%, Sodium sulfate6.5%, Protease 0.4%.

### Composition of Model Detergent A (Liquid)

Ingredients: 12% LAS, 11% AEO Biosoft N25-7 (NI), 7% AEOS (SLES), 6% MPG (monopropylene glycol), 3% ethanol, 3% TEA, 2.75% cocoa soap, 2.75% soya soap, 2% glycerol, 2% sodium hydroxide, 2% sodium citrate, 1% sodium formiate, 0.2% DTMPA and 0.2% PCA (all percentages are w/w)

### Composition of Persil Small & Mighty (Liquid)

Ingredients: 15-30% Anionic surfactants, Non-ionic surfacts, 5-15% Soap, <5% Polycarboxylates, Perfume, Phosphates, Optical Brighteners

Persil 2 in 1 with Comfort Passion Flower Powder

Sodium sulfate, Sodium carbonate, Sodium Dodecylbenzenesulfonate, Bentonite, Sodium Carbonate Peroxide, Sodium Silicate, Zeolite, Aqua, Citric acid, TAED, C12-15 Pareth-7, Stearic Acid, Parfum, Sodium Acrylic Acid/MA Copolymer, Cellulose Gum, Corn Starch Modified, Sodium chloride, Tetrasodium Etidronate, Calcium Sodium EDTMP, Disodium Anilinomorpholinotriazinyl-aminostilbenesulfonate, Sodium bicarbonate, Phenylpropyl Ethyl Methicone, Butylphenyl Methylpropional, Glyceryl Stearates, Calcium carbonate, Sodium Polyacrylate, Alpha-Isomethyl Ionone, Disodium Distyrylbiphenyl Disulfonate, Cellulose, Protease, Limonene, PEG-75, Titanium dioxide, Dextrin, Sucrose, Sodium Polyaryl Sulphonate, CI 12490, CI 45100, CI 42090, Sodium Thiosulfate, CI 61585.

### Persil Biological Powder

Sucrose, Sorbitol, Aluminum Silicate, Polyoxymethylene Melamine, Sodium Polyaryl Sulphonate, CI 61585, CI 45100, Lipase, Amylase, Xanthan gum, Hydroxypropyl methyl cellulose, CI 12490, Disodium Distyrylbiphenyl Disulfonate, Sodium Thiosulfate, CI 42090, Mannanase, CI 11680, Etidronic Acid, Tetrasodium EDTA.

### Persil Biological Tablets

Sodium carbonate, Sodium Carbonate Peroxide, Sodium bicarbonate, Zeolite, Aqua, Sodium Silicate, Sodium Lauryl Sulfate, Cellulose, TAED, Sodium Dodecylbenzenesulfonate, Hemicellulose, Lignin, Lauryl Glucoside, Sodium Acrylic Acid/MA Copolymer, Bentonite, Sodium chloride, Parfum, Tetrasodium Etidronate, Sodium sulfate, Sodium Polyacrylate, Dimethicone, Disodium Anilinomorpholinotriazinylaminostilbenesulfonate, Dodecylbenzene Sulfonic Acid, Trimethylsiloxysilicate, Calcium carbonate, Cellulose, PEG-75, Titanium dioxide, Dextrin, Protease, Corn Starch Modified, Sucrose, CI 12490, Sodium Polyaryl Sulphonate, Sodium Thiosulfate, Amylase, Kaolin,

### Persil Colour Care Biological Powder

Subtilisin, Imidazolidinone, Hexyl Cinnamal, Sucrose, Sorbitol, Aluminum Silicate, Polyoxymethylene Melamine, CI 61585, CI 45100, Lipase, Amylase, Xanthan gum, Hydroxypropyl methyl cellulose, CI 12490, Disodium Distyrylbiphenyl Disulfonate, Sodium Thiosulfate, CI 42090, Mannanase, CI 11680, Etidronic Acid, Tetrasodium EDTA.

### Persil Colour Care Biological Tablets

Sodium bicarbonate, Sodium carbonate, Zeolite, Aqua, Sodium Silicate, Sodium Lauryl Sulfate, Cellulose Gum, Sodium Dodecylbenzenesulfonate, Lauryl Glucoside, Sodium chloride, Sodium Acrylic Acid/MA Copolymer, Parfum, Sodium Thioglycolate, PVP, Sodium sulfate, Tetrasodium Etidronate, Sodium Polyacrylate, Dimethicone, Bentonite, Dodecylbenzene Sulfonic Acid, Trimethylsiloxysilicate, Calcium carbonate, Cellulose, PEG-75, Titanium dioxide, Dextrin, Protease, Corn Starch Modified, Sucrose, Sodium Thiosulfate, Amylase, CI 74160, Kaolin.

### Persil Dual Action Capsules Bio

MEA-Dodecylbenzenesulfonate, MEA-Hydrogenated Cocoate, C12-15 Pareth-7, Dipropylene Glycol, Aqua, Tetrasodium Etidronate, Polyvinyl Alcohol, Glycerin, Aziridine, homopolymer ethoxylated, Propylene glycol, Parfum, Sodium Diethylenetriamine Pentamethylene Phosphonate, Sorbitol, MEA-Sulfate, Ethanolamine, Subtilisin, Glycol, Butylphenyl Methylpropional, Boronic acid, (4-formylphenyl), Hexyl Cinnamal, Limonene, Linalool, Disodium Distyrylbiphenyl Disulfonate, Alpha-Isomethyl Ionone, Geraniol, Amylase, Polymeric Blue Colourant, Polymeric Yellow Colourant, Talc, Sodium chloride, Benzisothiazolinone, Mannanase, Denatonium Benzoate.

Persil 2 in 1 with Comfort Sunshiny Days Powder

Sodium sulfate, Sodium carbonate, Sodium Dodecylbenzenesulfonate, Bentonite, Sodium Carbonate Peroxide, Sodium Silicate, Zeolite, Aqua, Citric acid, TAED, C12-15 Pareth-7, Parfum, Stearic Acid, Sodium Acrylic Acid/MA Copolymer, Cellulose Gum, Corn Starch Modified, Sodium chloride, Tetrasodium Etidronate, Calcium Sodium EDTMP, Disodium Anilinomorpholinotriazinyl-aminostilbenesulfonate, Sodium bicarbonate, Phenylpropyl Ethyl Methicone, Butylphenyl Methylpropional, Glyceryl Stearates, Calcium carbonate, Sodium Polyacrylate, Geraniol, Disodium Distyrylbiphenyl Disulfonate, Cellulose, Protease, PEG-75, Titanium dioxide, Dextrin, Sucrose, Sodium Polyaryl Sulphonate, CI 12490, CI 45100, CI 42090, Sodium Thiosulfate, CI 61585.

Persil Small & Mighty 2in 1 with Comfort Sunshiny Days

Aqua, C12-15 Pareth-7, Sodium Dodecylbenzenesulfonate, Propylene glycol, Sodium Hydrogenated Cocoate, Triethanolamine, Glycerin, TEA-Hydrogenated Cocoate, Parfum, Sodium chloride, Polyquaternium-10, PVP, Polymeric Pink Colourant, Sodium sulfate, Disodium Distyrylbiphenyl Disulfonate, Butylphenyl Methylpropional, Styrene/Acrylates Copolymer, Hexyl Cinnamal, Citronellol, Eugenol, Polyvinyl Alcohol, Sodium acetate, Isopropyl alcohol, Polymeric Yellow Colourant, Sodium Lauryl Sulfate.

### Persil Small & Mighty Bio

Aqua, MEA-Dodecylbenzenesulfonate, Propylene glycol, Sodium Laureth Sulfate, C12-15 Pareth-7, TEA-Hydrogenated Cocoate, MEA-Citrate, Aziridine homopolymer ethoxylated, MEA-Etidronate, Triethanolamine, Parfum, Acrylates Copolymer, Sorbitol, MEA-Sulfate, Sodium Sulfite, Disodium Distyrylbiphenyl Disulfonate, Butylphenyl Methylpropional, Styrene/Acrylates Copolymer, Citronellol, Sodium sulfate, Peptides, salts, sugars from fermentation (process), Subtilisin, Glycerin, Boronic acid, (4-formylphenyl), Geraniol, Pectate Lyase, Amylase, Sodium Lauryl Sulfate, Mannanase, CI 42051.

### Persil Small & Mighty Capsules Biological

MEA-Dodecylbenzenesulfonate, MEA-Hydrogenated Cocoate, C12-15 Pareth-7, Dipropylene Glycol, Aqua, Glycerin, Polyvinyl Alcohol, Parfum, Aziridine homopolymer ethoxylated, Sodium Diethylenetriamine Pentamethylene Phosphonate, Propylene glycol, Sorbitol, MEA-Sulfate, Ethanolamine, Subtilisin, Glycol, Butylphenyl Methylpropional, Hexyl Cinnamal, Starch, Boronic acid, (4-formylphenyl), Limonene, Linalool, Disodium Distyrylbiphenyl Disulfonate, Alpha-Isomethyl lonone, Geraniol, Amylase, Talc, Polymeric Blue Colourant, Sodium chloride, Benzisothiazolinone, Denatonium Benzoate, Polymeric Yellow Colourant, Mannanase.

### Persil Small & Mighty Capsules Colour Care

MEA-Dodecylbenzenesulfonate, MEA-Hydrogenated Cocoate, C12-15 Pareth-7, Dipropylene Glycol, Aqua, Glycerin, Polyvinyl Alcohol, Parfum, Aziridine homopolymer ethoxylated, Sodium Diethylenetriamine Pentamethylene Phosphonate, Propylene glycol, MEA-Sulfate, Ethanolamine, PVP, Sorbitol, Butylphenyl Methylpropional, Subtilisin, Hexyl Cinnamal, Starch, Limonene, Linalool, Boronic acid, (4-formylphenyl), Alpha-Isomethyl lonone, Geraniol, Talc, Polymeric Blue Colourant, Denatonium Benzoate, Polymeric Yellow Colourant.

### Persil Small & Mighty Colour Care

Aqua, MEA-Dodecylbenzenesulfonate, Propylene glycol, Sodium Laureth Sulfate, C12-15 Pareth-7, TEA-Hydrogenated Cocoate, MEA-Citrate, Aziridine homopolymer ethoxylated, MEA-Etidronate, Triethanolamine, Parfum, Acrylates Copolymer, Sorbitol, MEA-Sulfate, Sodium Sulfite, Glycerin, Butylphenyl Methylpropional, Citronellol, Sodium sulfate, Peptides, salts, sugars from fermentation (process), Styrene/Acrylates Copolymer, Subtilisin, Boronic acid, (4-formylphenyl), Geraniol, Pectate Lyase, Amylase, Sodium Lauryl Sulfate, Mannanase, CI 61585, CI 45100.

### Composition of Persil Small & Mighty (Liquid)

Ingredients: 15-30% Anionic surfactants, Non-ionic surfacts, 5-15% Soap, <5% Polycarboxylates, Perfume, Phosphates, Optical Brighteners

### Composition of Persil Megaperls (Powder)

Ingredients: 15-30% of the following: anionic surfactants, oxygen-based bleaching agent and zeolites, less than 5% of the following: non-ionic surfactants, phosphonates, polycarboxylates, soap, Further ingredients: Perfumes, Hexyl cinnamal, Benzyl salicylate, Linalool, optical brighteners, Enzymes and Citronellol.

### HEY SPORT TEX WASH Detergent

Aqua, dodecylbenzenesulfonsaure, laureth-11, peg-75 lanolin, propylene glycol, alcohol denat., potassium soyate, potassium hydroxide, disodium cocoamphodiacetate, ethylendiamine triacetate cocosalkyl acetamide, parfum, zinc ricinoleate, sodium chloride, benzisothiazolinone, methylisothiazolinone, ci 16255, benzyl alcohol.

### Composition of Ariel Sensitive White & Color, Liquid Detergent Composition

Aqua, Alcohol Ethoxy Sulfate, Alcohol Ethoxylate, Amino Oxide, Citrid Acid, C12-18 topped palm kernel fatty acid, Protease, Glycosidase, Amylase, Ethanol, 1,2 Propanediol, Sodium Formate, Calcium Chloride, Sodium hydroxide, Silicone Emulsion, Trans-sulphated EHDQ (the ingredients are listed in descending order).

### Composition of Ariel Actilift (Liquid)

Ingredients: 5-15% Anionic surfactants; <5% Non-ionic surfactants, Phosphonates, Soap; Enzymes, Optical brighteners, Benzisothiazolinone, Methylisothiazolinone, Perfumes, Alpha-isomethyl ionone, Citronellol, Geraniol, Linalool.

### Composition of Ariel Actilift (Powder)

Ingredients: 15-30% Anionic surfactants, <5% Non-ionic surfactants, Phosphonates,

Polycarboxylates, Zeolites; Enzymes, Perfumes, Hexyl cinnamal.

### Composition of Model Detergent T (Powder)

Ingredients: 11% LAS, 2% AS/AEOS, 2% soap, 3% AEO, 15.15% sodium carbonate, 3% sodium slilcate, 18.75% zeolite, 0.15% chelant, 2% sodium citrate, 1.65% AA/MA copolymer, 2.5% CMC and 0.5% SRP (all percentages are w/w).

### Composition of Model Detergent X (Powder)

Ingredients: 16.5% LAS, 15% zeolite, 12% sodium disilicate, 20% sodium carbonate, 1% sokalan, 35.5% sodium sulfate (all percentages are w/w).

### Tide Liquid, Original:

Ingredients: Linear alkylbenzene sulfonate , propylene glycol, citric acid, sodium hydroxide, borax, ethanolamine, ethanol , alcohol sulfate, polyethyleneimine ethoxylate, sodium fatty acids, diquaternium ethoxysulfate, protease, diethylene glycol, laureth-9, alkyldimethylamine oxide, fragrance, amylase, disodium diaminostilbene disulfonate, DTPA, sodium formate, calcium formate, polyethylene glycol 4000, mannanase, Liquitint™ Blue, dimethicone.

Tide Coldwater Liquid, Fresh Scent: Water, alcoholethoxy sulfate, linear alkylbenzene sulfonate, diethylene glycol, propylene glycol, ethanolamine, citric acid, Borax, alcohol sulfate, sodium hydroxide, polyethyleneimine, ethoxylate, sodium fatty acids, ethanol, protease, Laureth-9, diquaternium ethoxysulfate, lauramine oxide, sodium cumene, sulfonate, fragrance, DTPA, amylase, disodium, diaminostilbene, disulfonate, sodium formate, disodium distyrylbiphenyl disulfonate, calcium formate, polyethylene glycol 4000, mannanase, pectinase, Liquitint™ Blue, dimethicone

Liquid Tide Plus Bleach Alternative™, Vivid White and Bright, Original and Clean Breeze: Water, sodium alcoholethoxy sulfate, sodium alkyl sulfate, MEA citrate, linear alkylbenzene sulfonate, MEA salt, propylene glycol, diethylene glycol, polyethyleneimine ethoxylate, ethanol, sodium fatty acids, ethanolamine, lauramine oxide, borax, Laureth-9, DTPA, sodium cumene sulfonate, sodium formate, calcium formate, linear alkylbenzene sulfonate, sodium salt, alcohol sulfate, sodium hydroxide, diquaternium ethoxysulfate, fragrance, amylase, protease, mannanase, pectinase, disodium diaminostilbene disulfonate, benzisothiazolinone, Liquitint™ Blue, dimethicone, dipropylethyl tetraamine.

Tide Simply Clean & Fresh: Water, alcohol ethoxylate sulfate, linear alkylbenzene sulfonate Sodium/Mea salts, propylene glycol, diethylene glycol, sodium formate, ethanol, borax, sodium fatty acids, fragrance, lauramine oxide, DTPA, Polyethylene amine ethoxylate, calcium formate, disodium diaminostilbene disulfonate, dimethicone, tetramine, Liquitint™ Blue.

Tide Pods, Ocean Mist, Mystic Forest, Spring Meadow: Linear alkylbenzene sulfonates, C12-16 Pareth-9, propylene glycol, alcoholethoxy sulfate, water, polyethyleneimine ethoxylate, glycerine, fatty acid salts, PEG-136 polyvinyl acetate, ethylene Diamine disuccinic salt, monoethanolamine citrate, sodium bisulfite, diethylenetriamine pentaacetate sodium, disodium distyrylbiphenyl disulfonate, calcium formate, mannanase, exyloglucanase, sodium formate, hydrogenated castor oil, natalase, dyes, termamyl, subtilisin, benzisothiazolin, perfume.

Tide to Go: Deionized water, Dipropylene Glycol Butyl Ether, Sodium Alkyl Sulfate, Hydrogen Peroxide, Ethanol, Magnesium Sulfate, Alkyl Dimethyl Amine Oxide, Citric Acid, Sodium Hydroxide, Trimethoxy Benzoic Acid, Fragrance.

Tide Stain Release Liquid: Water, Alkyl Ethoxylate, Linear Alkylbenzenesulfonate, Hydrogen Peroxide, Diquaternium Ethoxysulfate, Ethanolamine, Disodium Distyrylbiphenyl Disulfonate, tetrabutyl Ethylidinebisphenol, F&DC Yellow 3, Fragrance.

Tide Stain Release Powder: Sodium percarbonate, sodium sulfate, sodium carbonate, sodium aluminosilicate, nonanoyloxy benzene sulfonate, sodium polyacrylate, water, sodium alkylbenzenesulfonate, DTPA, polyethylene glycol, sodium palmitate, amylase, protease, modified starch, FD&C Blue 1, fragrance.

Tide Stain Release, Pre Treater Spray:

Water, Alkyl Ethoxylate, MEA Borate, Linear Alkylbenzenesulfonate, Propylene Glycol, Diquaternium Ethoxysulfate, Calcium Chlorideenzyme, Protease, Ethanolamine, Benzoisothiazolinone, Amylase, Sodium Citrate, Sodium Hydroxide, Fragrance.

Tide to Go Stain Eraser: Water, Alkyl Amine Oxide, Dipropylene Glycol Phenyl Ether, Hydrogen Peroxide, Citric Acid, Ethylene Diamine Disuccinic Acid Sodium salt, Sodium Alkyl Sulfate, Fragrance.

Tide boost with Oxi:

Sodium bicarbonate, sodium carbonate, sodium percarbonate, alcohol ethoxylate, sodium chloride, maleic/acrylic copolymer, nonanoyloxy benzene sulfonate, sodium sulfate, colorant, diethylenetriamine pentaacetate sodium salt, hydrated aluminosilicate (zeolite), polyethylene glycol, sodium alkylbenzene sulfonate, sodium palmitate, starch, water, fragrance.

Ultra Tide Free Powdered Detergent: Sodium Carbonate, Sodium Aluminosilicate, Alkyl Sulfate, Sodium Sulfate, Linear Alkylbenzene Sulfonate, Water, Sodium polyacrylate, Silicate, Ethoxylate, Sodium percarbonate, Polyethylene Glycol 4000, Protease, Disodium Diaminostilbene Disulfonate, Silicone, Cellulase.

### Assays

### Assay I: Determination of Biochemical Oxygen Demand (BOD_{S}), Reference: Danish Standard/R 254

### General Principle:

The sample is diluted with oxygen containing water. The diluted sample is than allowed to stand in closed bottles in the dark for 120±4 hours at 20 ±0.5° C. BOD is calculated from the difference in dissolved oxygen content of the diluted sample before and after incubation.

### Apparatus:

1. 200-300 ml glas bottles with glas stopper
2. 20±1° C. incubator

### Reagents:

1. Phosphate buffer: Dissolve 8.5 g KH₂PO₄, 21.75 g K₂HPO₄, 33.4 g Na₂HPO₄.7H₂O, and 1.7 g NH₄CI in water and dilute to a final volume of 1 L. The pH should be 7.2. Store in 4° C. refrigerator.
2. Magnesium sulfate solution: Dissolve 22.5 g MgSO₄.7H20 in water and dilute to 1 L.
3. Calcium chloride solution: Dissolve 27.5 g CaCl₂ in water and dilute to 1 L.
4. Ferric Chloride solution: Dissolve 0.25 g FeCl₃.6H₂O in water and dilute to 1 L.
5. Dilution water: Deionized or distilled water is aerated for appr.15 min and allowed to stand for at 20° C. for at least one hour before use. BOD of the dilution water should be below 0.2 mg/L and not higher than 0.5 mg/L.
6. Glycose-glutamic acid solution: D-glucose and L-glutamic acid is dryed at 103° C. and is stored in an desiccator. Dissolve 0.150 g D-glucose and 0.150 g L-glutamic acid and dilute to 1 L. To be freshly prepared daily.
7. Sodium sulfite solution: Dissolve 0.16 g water free Na₂SO₃ in water and dilute to 100 mL. To be freshly prepared daily.
8. Seed preparation: Domestic waste water is allowed to settle for at least two hours. BOD value should be within 100-500 mg/L and pH interval in the range between 6.5 and 8.5. In order to test the suitability of the seed a control test is performed with glucose-glutamic acid.

### Preparation of Sample:

1. The diluted sample used to determine BOD must have a pH between 6.5 and 8.5. As needed, neutralize samples with 1N sulfuric acid or 1N sodium hydroxide.
2. Test for residual chlorine. Dechlorination is required if a chlorine residual is present when testing is initiated. In this case adjust a subsample to pH 5 with sulphuric acid. Sodium iodid is added and the sample is titrated with sodium sulfite solution (reagent 7) until turning point using starch as indicator. Based on this the required amount of sulfite is calculated and added to the sample, which has been adjusted to pH 5. After shaking the sample is allowed to stand for 10 min before neutralization with diluted sodium hydroxide.
3. Samples supersaturated with dissolved oxygen, over about 8.6 mg/I at 20° C. need to be pretreated. To prevent loss of oxygen during incubation of these samples the DO should be reduced by shaking the sample or aerating it with filtered compressed air.
4. Adjust temperature to 20±2° C.

### Sampling

BOD analyses should be done as soon as possible after sampling and no later than 24 hours after.

Until analysis samples should be kept at 0-4° C.

### Control

The BOD value for glucose-glutamic acid solution is determined. The expected BOD for the solution should be within 218±11 mg/L.

### Determination of the Expected BOD of the Sample

Analysis should be performed within 24 h after sampling and thus cannot be repeated if no acceptable result is obtained after 5 days. A result is considered acceptable if the amount of oxygen consumption is below 80% and above 20% after 5 days incubation.

If it is not possible to estimate the ca. BOD value of the sample, the samples COD (Chemical Oxygen Demand) value should be determined before BOD analysis.

### Analysis

Based on the estimated BOD of the sample and suitable dilutions can be selected from the following table:

| Estimated | Suggested | Ca. BOD |
|---|---|---|
| BOD₅ | Sample Volume | Volume Covered |
| (mg/L) | (mL) | (mg/L) |
| <5 | 990 | 0-8 |
| 5 | 800 | 3-10 |
| 10 | 400 | 5-20 |
| 20 | 200 | 10-40 |
| 30 | 150 | 15-55 |
| 50 | 80.0 | 25-100 |
| 80 | 50.0 | 40-150 |
| 125 | 30.0 | 70-250 |
| 200 | 20.0 | 100-400 |
| 400 | 10.0 | 200-800 |
| 800 | 5.00 | 400-1500 |

The selected sample volume is transferred to a 1 L graduated cylinder. Dilution water is carefully added until the graduated cylinder is approximately 500 mL filled. Add 1 ml of reagent 1 to 4 per liter of dilution water and 1 to 5 mL seed corresponding to a BOD value of ca. 0.5. Fill the graduated cylinder up to the 1 L mark with dilution water by slowly and carefully adding the dilution water under constant stirring. Hereafter is the diluted sample distributed to three glass bottles, which are completely filled and immediately after closed with glass stopper. Avoid formation of air bobbles in the solution.

In one of the three bottles, the dissolved oxygen content is determined after ca. 15 min.

The two other bottles are incubated for 120±4 h at 20±0.5° C. After end incubation the dissolved oxygen content is determined.

Both the seed and the dilution water BOD value are also determined. Do not add seed, but only reagent 1-4 and proceed as described above without adding seed.

### Results

### Calculations:

The biochemical oxygen demand is calculated from the difference in dissolved oxygen between day 0 and day 5 according to following formula:

BOD (mg/L)=[(c₁-c₂)−P×(b/1000)−(F−0.2)×((1000−a−b)/1000)]×(1000/a)

where:
P=BOD of seed (mg/L)
F=BOD of dilution water (mg/L)
a=volume of sample (mL)
b=volume of seed (mL)
c₁=dissolved oxygen after 15 min (mg/L)
c₂=dissolved oxygen after 120 h (5 days) (mg/L)
c₂ should be within 0.2*c₁<c₂<0.8*c₁

Because the total oxygen consumption is not equal to the sum of the oxygen consumption of the sample, seed and dilution water, it is only corrected for the consumption of oxygen of the dilution water above 0.2 mg/L.

The above formula is also used for calculation of P and F. For calculation of F the correction factor a=996˜1000 and correction factor b=0 and for P the correction factor b=0. In addition c₂<0.8*c₁is not a requirement for F.

### Standardization of DO Meter—Winkler Titration Technique

Reference:Standard Methods, 18th edition, Procedure 4500-OC

### Reagents:

1. Manganous sulfate solution: Dissolve 480 g MnSO₄.H₂O in reagent water. Filter; dilute to 1 L.
2. Alkali-iodide-azide reagent: Dissolve 500 g NaOH and 135 g Nal in reagent water. Dilute to 1 L. Add 10 g NaN₃ dissolved in 40 ml reagent water. This reagent should not give a color with starch solution when diluted and acidified.
3. Concentrated Sulfuric acid
4. Standard sodium thiosulfate titrant, 0.0250N: Purchase commercially.
5. Starch Solution: Prepare an emulsion of 5 g soluble starch in a mortar or beaker with a small amount of distilled water. Pour this emulsion into 1 L of boiling water, allow to boil a few minutes, and let settle overnight. Use the clear supernate. This solution may be preserved by the addition of 1.25 g salicylic acid/L and storage at 4° C.

### Procedure:

1. Slowly siphon three portions of aerated dilution water into three separate BOD bottles. Avoid adding atmospheric O₂ to dilution water.
2. To two of the three BOD bottles, add 1 ml MnSO₄ solution, followed by 1 ml alkali-iodide-azide reagent. Submerge pipette tips in sample when adding reagents. Rinse tips well between uses.
3. Stopper carefully to exclude air bubbles; mix by inverting bottle several times.
4. When precipitate has settled to about half the bottle volume, carefully remove the stopper and add 1.0 ml conc. sulfuric acid. Re-stopper and mix by gentle inversion until the iodine is uniformly distributed throughout the bottle.
5. Transfer 203 ml of sample into a white 500 ml casserole dish and titrate with 0.0250N sodium thiosulfate to a pale straw color. Add 1-2 ml of starch solution and continue to titrate to first disappearance of the blue color. (200 ml of original dilution water is equal to 203 ml of dilution water plus reagents.)
6. Titrate two of the three samples. Results should be within 0.1 mL if using a buret with increments of 0.05 mL. Calibrate the DO probe with the third bottle.

### Standardization of DO Meter—Air Calibrations

| | Theoretical Maximum |
|---|---|
| Temperature (° C.) | Oxygen Solubility (mg/L) |
| 15 | 10.084 |
| 16 | 9.870 |
| 17 | 9.665 |
| 18 | 9.467 |
| 19 | 9.276 |
| 20 ambient | 9.092 |
| 21 | 8.915 |
| 22 | 8.743 |
| 23 | 8.578 |
| 24 | 8.418 |
| 25 | 8.263 |

### Calibration

The Winkler titration is the most accurate method for standardizing a DO meter. If another method is used, it is suggested that the calibration be checked against a Winkler titration occasionally. If a meter is air calibrated, the reading must be corrected for atmospheric pressure. This is best done with a barometer kept in the lab, but another source of this information is a local airport or news station. Atmospheric pressure readings obtained from an airport are generally corrected for sea level, and must be re-corrected for actual altitude.

If you use a DO meter and probe, it is perhaps easiest if you calibrate according to the manufacturer's instructions. There are two types of oxygen probes available: one of which employs a calibration based on water saturated air, and another based on air-saturated water. The water saturated air procedure involves storing the electrode in a sealed BOD bottle containing a minimal amount of water. For the air-saturated water calibration procedure, you either vigorously shake the solution or bubble air through it.

### Pretreatment of Chlorinated BOD Samples Reagents:

1. Acetic acid solution, 1+1: Add 500 ml. of concentrated acetic acid to 500 ml of distilled water.
2. Potassium Iodide Solution: Dissolve 10 grams KI in a 100 ml volumetric flask. Bring to volume with distilled water.
3. Sodium Sulfite Solution, 0.0250N: Dissolve 1.575 grams anhydrous NA₂SO₃ in a 1,000 ml volumetric flask. Bring to volume with distilled water.
   NOTE: This solution is not stable and must be prepared daily.
4. Starch Indicator Solution (For Analysis with Iodine): Prepare an emulsion of 5 g soluble starch in a mortar or beaker with a small amount of distilled water. Pour this emulsion into 1 L of boiling water, allow to boil a few minutes, and let settle overnight. Use the clear supernate. This solution may be preserved by the addition of 1.25 g salicylic acid/L and storage at 4° C.

### Procedure:

1. Conduct a chlorine residual analysis on a portion of the sample collected. Potassium iodide/starch paper can be used as a quick qualitative test for residual chlorine. If no residual is found, proceed with the BOD analysis utilizing seeded dilution water. If a residual is found, proceed with the following steps before initiating the BOD test.
2. Determination of Appropriate Volume of Sodium Sulfite
   a. Obtain a 200 ml portion of the sample to be tested.
   b. Add 10 ml of 1+1 acetic acid solution
   c. Add 10 ml of potassium iodine solution
   d. Add 2 ml starch
   e. Titrate with 0.0250N sodium sulfite. The end point has been reached when a clear color persists after complete mixing.
   f. Measure volume of 0.0250N sodium sulfite used.
3. Sample Pretreatment
   a. Obtain another 200 ml portion of the same sample used in Step 2.
   b. Add to the sample the same volume of 0.0250N sodium sulfite solution that was determined in Step 2.e and mix.
   c. Retest for residual chlorine after allowing the sample to stand for 10-20 minutes.
   d. If no residual chlorine is present, proceed with the BOD analysis. Samples which have been chlorinated must be seeded.

### Preparation of Glucose—Glutamic Acid Standard (GGA) Reagents:

Note: glucose/glutamic acid solution can be purchased commercially, but needs to be preapred usch that the GGA concentrations are equal to 150 mg/L each.
1. Reagent grade glucose
2. Reagent grade glutamic acid

### Procedure:

1. Dry reagent grade glucose and glutamic acid at 103° C. for 1 hour and cool for one hour in the desiccator.
2. Dissolve 150 mg (0.150 g) of glucose and 150 mg (0.150 g) of glutamic acid in distilled water and bring up to 1 L.
   Note: This solution will become contaminated quickly and must be used immediately unless the following is done. Place into each of several milk dilution bottles or capped test tubes the quantity of the GGA standard which is used in one day. Seal the bottles and sterilize them. These sterilized portions can then be cooled and stored at 4° C. When a known standard is run, 6 ml of GGA standard from one of the sealed/sterilized containers is added to each BOD₅ bottle and the bottles are filled ¾ full with dilution water. (This is critical! 198±30.5 mg Oxygen/L is based on a 2% dilution of GGA (6 mL/300). It is important not to use multiple dilutions which use other than 6 mL). Seed is then added and the bottle is filled with dilution water. These bottles are incubated and BOD is determined similar to sample bottles.
3. The acceptable BOD₅ value of the standard is 198±30.5 mg/I. If the calculated result falls outside this range the cause of the problem must be identified. Sample results obtained using the same seed or dilution water as the standard must be qualified. Once the problem is corrected another known should be set up immediately.

### BOD Seeding Procedure

### Preparation of Seed:

1. Collect a raw influent grab sample the day before performing the test. If the influent contains significant industrial loading, settled mixed liquor may provide a better seed than raw influent. If used for seed, settled mixed liquor does not need to be incubated at 20° C. overnight. Seed can also be commercially obtained. There are at least two products widely in use: BioSeed™, and PolySeed™.
2. Place sample in incubator (20° C.) overnight.

### Preparation of Seed Controls:

Table 8 gives general directions for determining the amount of seed to add to seed controls and samples.
1. Take the incubated raw influent sample out of the incubator—DO NOT MIX.
2. Pipet 3, 5, and 7 ml of the clear supernatant into three BOD bottles respectively. Use other volumes of supernatant based on the strength of your system. You MUST use at least two different dilutions.
3. Fill these three bottles with BOD dilution water.
4. Determine the initial dissolved oxygen on each of the three bottles.

### Preparation of Seeded BOD Samples:

1. Fill the bottles approximately ⅓-½ with dilution water.
2. Pipet 2 ml of the supernatant into each of the BOD sample bottles that will require seeding.
3. Add the appropriate amount of sample to each of the bottles.
4. Complete the filling of the BOD bottles with dilution water.
5. Determine the initial dissolved oxygen (I DO) on each of the bottles.

### Calculation of Seed Correction:

1. Determine the 5 day DO concentration on each of the seed controls.
2. Use the same rule for DO depletion as in all other BODs (at least 2.0 mg/L DO depletion and at least 1.0 mg/L residual DO (after 5 days) (Standard Methods, 18^{th} edition)).
3. If none of the bottles attain a proper depletion, adjust the amount of seed addition accordingly in subsequent tests.
4. For each seed control dilution, the mg DO used per ml seed=(IDO−DO₅ for seed control) ml seed in seed control
5. If two seed controls meet the DO depletion criteria, calculate the average mg DO depleted/mL seed.
6. Seed correction=(mg DO/ml seed in seed control)×(ml seed added to samples@)
   @ If the seed is diluted before it is added to the sample bottles, the ml of the diluted seed added to the sample bottle must be multiplied by a dilution factor. (Ex. If 10 ml seed+90 ml water are mixed to produce the seeding material, the dilution factor is 1/10.)
7. If the seed correction does not fall in the range of 0.6-1.0, but the seed controls met the DO depletion criteria, the amount of seed used in the sample bottles will have to be adjusted in subsequent tests.

### Calculation of BOD in Sample:

$${BOD}_{5} = BOD mg \text{/} l = [ ( IDO - {DO}_{5} ) - seed correction ] \times dilution factor$$

$${}^{*} dilution factor = \frac{300}{sample size ( mL )}$$

TABLE 8
BOD SEED DILUTION GUIDELINES

| (1) | | (3) | (4) |
|---|---|---|---|
| Estimated | (2) | # mL seed | # mL diluted |
| BOD of | Dilutions for | per BOD | seed (10 mL seed + |
| seed | Seed Control | bottle | 90 mL water) |
| 30 | 15, 25, 50 | 6-10 | NA |
| 50 | 15, 25, 50 | 4-6 | NA |
| 100 | 5, 10, 15 | 2-3 | NA |
| 150 | 5, 10, 15 | 1-2 | NA |
| 250 | 3, 5, 10 | 1 | 6-10 |
| 500 | 1, 3, 5 | 0.5 | 5 |

If the BOD of the seed is 150 mg/L or less, the seed may be added directly to the BOD samples without dilution. If dilution is necessary, use volumes noted in column (4). Set up the seed control dilutions as shown in column (2). Prepare seed controls with seed at full strength.

### Seed Correction Sample Calculation:

| SEED | | | | # mL | mg |
|---|---|---|---|---|---|
| CONTROL | | | | SEED IN | DO/mL |
| BOTTLE | IDO | DO₅ | DEPLETION | BOTTLE | SEED |
| A | 8.5 | 0.3 | 8.2 | 30 | -.-- |
| B | 8.4 | 1.6 | 6.8 | 20 | 0.34 |
| C | 8.4 | 4.3 | 4.1 | 10 | 0.41 |

NOTE:
Bottle A is not used due to the insufficient final DO. There must be a residual DO of at least 1.0 mg/L after 5 days.

(0.34+0.41)/2=0.375 mg DO/ml seed
If 2 ml undiluted seed added to each sample bottle, seed correction=(0.375 mg DO/ml seed)(2 ml seed)=0.75 mg DO

### Assay II

### Terg-O-Tometer (TOM) Wash Assay

The Tergo-To-Meter (TOM) is a medium scale model wash system that can be applied to test 12 different wash conditions simultaneously. A TOM is basically a large temperature controlled water bath with up to 12 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash.

The TOM model wash system is mainly used in medium scale testing of detergents and enzymes at US or LA/AP wash conditions. In a TOM experiment, factors such as the ballast to soil ratio and the fabric to wash liquor ratio can be varied. Therefore, the TOM provides the link between small scale experiments, such as AMSA and mini-wash, and the more time consuming full scale experiments in top loader washing machines.

Equipment: The water bath with 12 steel beakers and 1 rotating arm per beaker with capacity of 600 or 1200 mL of detergent solution. Temperature ranges from 5 to 80° C. The water bath has to be filled up with deionised water. Rotational speed can be set up to 70 to 120 rpm/min. Set temperature in the Terg-O-Tometer and start the rotation in the water bath. Wait for the temperature to adjust (tolerance is +/−0.5° C.)

All beakers shall be clean and without traces of prior test material.

Prepare wash solution with desired amount of detergent, temperature and water hardness in a bucket. Let detergent dissolve during magnet stirring for 10 min. Wash solution shall be used within 30 to 60 min after preparation.

### Assay III

After being washed and rinsed the swatches were spread out flat and allowed to air dry at room temperature overnight. All washes are evaluated the day after the wash. Light reflectance evaluations of the swatches were done using a Macbeth Color Eye 7000 reflectance spectrophotometer with very small aperture. The measurements were made without UV in the incident light and remission at 460 nm was extracted.

### EXAMPLES

### Example 1

Name of swatches used in the example

EMPA 112, milk/cocoa
EMPA 118/1
Wfk 20 MU, Make-up
Wfk 10 D, pigment/sebum
KC-S- 062, LARD, Coloured
EMPA 106, oil/carbon black
Wfk 10 TE, clay
EMPA 101, olive oil/carbon black
EMPA 116, blood/milk
EMPA 117, blood/milk/ink
EMPA 164, grass
EMPA 114, red wine
Wfk 10 U, curry
C-S-20, tomato
Wfk 10 WB, Blueberry Juice
C-S-27, potato starch
C-S-28, rice starch
P01KC, tangerine
C-S-06, salad dressing
Wfk 10 A, 100% cotton, pre-washed
Wfk 30 A, 100% polyester, pre-washed

DETERGENT

| Name | Dosage |
|---|---|
| Nonionic model detergent composition specified below | 2.9 g/L |

| Nonionic model detergent composition(recipy) | purity | wt % |
|---|---|---|
| Soap-coco | 100 | 2.75 |
| Soap-soy | 100 | 2.75 |
| AEO Biosoft N25-7 (NI) | 100 | 16.11 |
| NaOH | 100 | 0.90 |
| Ethanol | 100 | 3.00 |
| MPG | 100 | 6.00 |
| glycerol | 85 | 2.00 |
| TEA | 100 | 3.00 |
| sodium formiate | 100 | 1.00 |
| sodium citrate | 100 | 2.00 |
| DTMPA (phosphonate) | 100 | 0.20 |
| PCA (Sokalan CP-5) | 100 | 0.20 |
| ion exchanged water | 100 | 59.77 |
| Final adjustment with Citric acid to pH 7.8 | | |

NaCl g per 600 mL wash liquor

| % | gram |
|---|---|
| 3.5 | 21 |
| 3 | 18 |
| 2 | 12 |
| 1 | 6 |
| 0.5 | 3 |

ENZYMES

| | Dosage (ppm | Required amount of |
|---|---|---|
| | active enzyme | enzyme product per |
| Name | protein) | liter wash solution (g) |
| Lipase as defined | 0.34 | 0.0172 |
| in SEQ ID NO: 2 | | |
| Protease as shown | 3.20 | 0.0768 |
| in SEQ ID NO: 1 | | |
| Amylase as shown | 1.50 | 0.1080 |
| in SEQ ID NO: 3 | | |
| Cellulase as shown | 1.50 | 0.094 |
| in SEQ ID NO: 5 | | |
| Pectate Lyase as shown | 1.00 | 0.081 |
| in SEQ ID NO: 6 | | |
| Mannanase as shown | 1.00 | 0.218 |
| in SEQ ID NO: 7 | | |

The swatches are washed as described in Assay II (TOM wash) with the below conditions:

Wash time: 30 min, Temp=22° C., where tracers are 2 swatches of wfk 10A and 30A

Procedure for TOM wash, all washes was done in repetition:
1. The TOM was turned on at 30° C.
2. Beakers and stir bars were placed in the TOM
3. The agitation was set to 110 rpm
4. The detergent and NaCl was weighed of and dissolved in 600 ml water for 5 minutes while agitation was on
5. The textiles were added to the beakers and the washes were started for those beaker washed without enzymes
6. For the beakers washed with enzymes the washes started when the enzymes were added to the beakers directly after the textiles
7. Each beaker washed for 30 minutes before agitation was stopped and the wash liquor discarded; swatches was squeezed and added back in the TOM beaker.
8. Rinse was started when 400 mL cold tap water and agitation of 110 rpm was applied
9. The rinse ran for 5 min
10. After the rinse, the water was discarded and the swatches were placed in a sieve to let the water drip off and the swatches sorted.
11. All marked swatches were put on a tray covered with paper and topped with another layer of paper, and dried overnight.
12. When they were dry, the swatches were measured on Color Eye, large aperture, no UV light at 460 nm. 2 swatches of same type from same beaker were placed upon each other while it was measured
13. Calculation of results was done by subtracting the remission results from was with enzymes from wash without enzymes.
   Beaker overview for the wash without enzymes

| | 1 | 2 | 3 | 4 | 5 | 6 | 7 | 8 | 9 | 10 | 11 | 12 |
|---|---|---|---|---|---|---|---|---|---|---|---|---|
| NaCl g | 21 | 21 | 18 | 18 | 12 | 12 | 6 | 6 | 3 | 3 | 0 | 0 |

Beaker overview for the wash with enzymes added

| | 1 | 2 | 3 | 4 | 5 | 6 | 7 | 8 | 9 | 10 | 11 | 12 |
|---|---|---|---|---|---|---|---|---|---|---|---|---|
| NaCl g | 21 | 21 | 18 | 18 | 12 | 12 | 6 | 6 | 3 | 3 | 0 | 0 |
| Lipase as | 500 | 500 | 500 | 500 | 500 | 500 | 500 | 500 | 500 | 500 | 500 | 500 |
| defined in | μl | μl | μl | μl | μl | μl | μl | μl | μl | μl | μl | μl |
| SEQ ID | | | | | | | | | | | | |
| NO: 2 | | | | | | | | | | | | |
| Protease | 500 | 500 | 500 | 500 | 500 | 500 | 500 | 500 | 500 | 500 | 500 | 500 |
| as shown in | μl | μl | μl | μl | μl | μl | μl | μl | μl | μl | μl | μl |
| SEQ ID | | | | | | | | | | | | |
| NO: 1 | | | | | | | | | | | | |
| Amylase as | 500 | 500 | 500 | 500 | 500 | 500 | 500 | 500 | 500 | 500 | 500 | 500 |
| shown in | μl | μl | μl | μl | μl | μl | μl | μl | μl | μl | μl | μl |
| SEQ ID | | | | | | | | | | | | |
| NO: 3 | | | | | | | | | | | | |
| Cellulase | 500 | 500 | 500 | 500 | 500 | 500 | 500 | 500 | 500 | 500 | 500 | 500 |
| as shown in | μl | μl | μl | μl | μl | μl | μl | μl | μl | μl | μl | μl |
| SEQ ID | | | | | | | | | | | | |
| NO: 5 | | | | | | | | | | | | |
| Pectate | 47 | 47 | 47 | 47 | 47 | 47 | 47 | 47 | 47 | 47 | 47 | 47 |
| Lyase as | μl | μl | μl | μl | μl | μl | μl | μl | μl | μl | μl | μl |
| shown in | | | | | | | | | | | | |
| SEQ ID | | | | | | | | | | | | |
| NO: 6 | | | | | | | | | | | | |
| Mannanase | 500 | 500 | 500 | 500 | 500 | 500 | 500 | 500 | 500 | 500 | 500 | 500 |
| as shown in | μl | μl | μl | μl | μl | μl | μl | μl | μl | μl | μl | μl |
| SEQ ID | | | | | | | | | | | | |
| NO: 7 | | | | | | | | | | | | |

### EVALUATION

Color Eye measurements, remission at 460 nm, no UV, large aperture as described in Assay III.

### Results:

Delta remission value (A.Rem) is the result of a reflectance or remission measurement at a wavelength of 460 nm. The swatch is measured with one swatch of similar colour as background, preferably a swatch from a repetition wash. A swatch representing each swatch type is measured before the wash. The Delta remission is the remission value of the swatch washed with enzymes minus the remission value of the swatch washed without enzymes.

TABLE 1

| | | | remission after wash (STDV) | | | | | | delta remission | | | | | |
|---|---|---|---|---|---|---|---|---|---|---|---|---|---|---|
| | | | 21 | 18 | 12 | 6 | 3 | 0 | 21 | 18 | 12 | 6 | 3 | 0 |
| | | | g | g | g | g | g | g | g | g | g | g | g | g |
| Swatches | enzymes | Unwashed | NaCl | NaCl | NaCl | NaCl | NaCl | NaCl | NaCl | NaCl | NaCl | NaCl | NaCl | NaCl |
| EMPA 112, | +. | 24 | 42 | 43 | 44 | 45 | 48 | 47 | 9 | 8 | 10 | 13 | 14 | 14 |
| milk/coca | | | (1) | (1) | (0) | (1) | (0) | (2) | | | | | | |
| EMPA 112, | −. | 24 | 33 | 35 | 34 | 32 | 34 | 33 | | | | | | |
| milk/coca | | | (2) | (0) | (1) | (1) | (0) | (1) | | | | | | |
| EMPA 118, | +. | 46 | 54 | 54 | 54 | 55 | 54 | 57 | 1 | 0 | 0 | 2 | −1 | 2 |
| sebum/pigment | | | (1) | (1) | (0) | (0) | (1) | (0) | | | | | | |
| EMPA 118, | −. | 46 | 53 | 54 | 55 | 53 | 54 | 54 | | | | | | |
| sebum/pigment | | | (1) | (0) | (1) | (1) | (0) | (1) | | | | | | |
| WFK 20 MU, | +. | 48 | 60 | 61 | 61 | 61 | 62 | 62 | 0 | 1 | 1 | 1 | 0 | 2 |
| Make-up | | | (0) | (1) | (1) | (0) | (1) | (1) | | | | | | |
| WFK 20 MU, | −. | 48 | 60 | 60 | 60 | 61 | 62 | 60 | | | | | | |
| Make-up | | | (2) | (0) | (1) | (1) | (0) | (0) | | | | | | |
| WFK 10 D, | +. | 46 | 57 | 55 | 56 | 57 | 58 | 58 | 1 | 0 | 2 | 1 | 2 | 4 |
| pigment/sebum | | | (3) | (2) | (2) | (2) | (2) | (1) | | | | | | |
| WFK 10 D, | −. | 46 | 56 | 56 | 54 | 56 | 56 | 54 | | | | | | |
| pigment/sebum | | | (1) | (1) | (1) | (1) | (1) | (2) | | | | | | |
| KC-S-062, lard | +. | 18 | 28 | 27 | 26 | 29 | 29 | 30 | 0 | −1 | −1 | 1 | 4 | 4 |
| coloured | | | (2) | (1) | (2) | (0) | (1) | (1) | | | | | | |
| KC-S-062, lard | −. | 18 | 28 | 28 | 27 | 28 | 25 | 27 | | | | | | |
| coloured | | | (0) | (0) | (1) | (0) | (1) | (0) | | | | | | |
| EMPA 106, | +. | 27 | 36 | 35 | 33 | 38 | 34 | 36 | 3 | 3 | 0 | 5 | −1 | 2 |
| oil/carbon black | | | (2) | (2) | (0) | (0) | (3) | (1) | | | | | | |
| EMPA 106, | −. | 27 | 33 | 32 | 33 | 33 | 35 | 34 | | | | | | |
| oil/carbon black | | | (0) | (2) | (0) | (1) | (0) | (1) | | | | | | |
| WFK 10 TE, clay | +. | 60 | 61 | 62 | 62 | 62 | 61 | 64 | 0 | 0 | 1 | 2 | 0 | 1 |
| | | | (1) | (0) | (1) | (0) | (0) | (1) | | | | | | |
| WFK 10 TE, clay | −. | 60 | 62 | 61 | 61 | 62 | 60 | 62 | | | | | | |
| | | | (0) | (0) | (1) | (0) | (0) | (0) | | | | | | |
| EMPA 101, olive | +. | 16 | 24 | 25 | 25 | 27 | 28 | 27 | −1 | 2 | 2 | 3 | 4 | 3 |
| oil/carbon black | | | (1) | (1) | (2) | (0) | (1) | (0) | | | | | | |
| EMPA 101, olive | −. | 16 | 25 | 22 | 23 | 23 | 24 | 24 | | | | | | |
| oil/carbon black | | | (1) | (1) | (0) | (1) | (1) | (0) | | | | | | |
| EMPA 116, | +. | 13 | 29 | 27 | 34 | 39 | 40 | 32 | 10 | 8 | 14 | 19 | 18 | 15 |
| blood/milk | | | (0) | (2) | (2) | (0) | (1) | (1) | | | | | | |
| EMPA 116, | −. | 13 | 18 | 19 | 19 | 20 | 22 | 17 | | | | | | |
| blood/milk | | | (0) | (2) | (2) | (2) | (1) | (1) | | | | | | |
| EMPA 117, | +. | 9 | 26 | 27 | 31 | 42 | 47 | 30 | 5 | 6 | 8 | 17 | 22 | 12 |
| blodd/milk/ink | | | (0) | (0) | (0) | (1) | (1) | (1) | | | | | | |
| EMPA 117, | −. | 9 | 21 | 21 | 23 | 25 | 25 | 19 | | | | | | |
| blodd/milk/ink | | | (0) | (1) | (1) | (0) | (1) | (0) | | | | | | |
| EMPA 164, grass | +. | 29 | 37 | 38 | 38 | 38 | 41 | 37 | 1 | 2 | 2 | 3 | 6 | 3 |
| | | | (1) | (2) | (1) | (1) | (0) | (0) | | | | | | |
| EMPA 164, grass | −. | 29 | 35 | 36 | 35 | 35 | 35 | 34 | | | | | | |
| | | | (1) | (0) | (0) | (0) | (1) | (0) | | | | | | |
| EMPA 114, red | +. | 48 | 49 | 51 | 50 | 52 | 54 | 53 | −1 | 0 | −2 | 0 | 1 | 1 |
| wine | | | (1) | (0) | (1) | (0) | (0) | (1) | | | | | | |
| EMPA 114, red | −. | 48 | 50 | 51 | 52 | 52 | 53 | 52 | | | | | | |
| wine | | | (0) | (2) | (0) | (1) | (0) | (0) | | | | | | |
| WFK 10 U, curry | +. | 47 | 57 | 57 | 58 | 58 | 59 | 58 | 0 | 0 | 1 | 1 | 1 | 2 |
| | | | (0) | (1) | (0) | (1) | (0) | (0) | | | | | | |
| WFK 10 U, curry | −. | 47 | 57 | 57 | 57 | 57 | 57 | 57 | | | | | | |
| | | | (0) | (0) | (0) | (0) | (0) | (0) | | | | | | |
| C-S-20, tomato | +. | 45 | 51 | 53 | 52 | 53 | 54 | 54 | −2 | 0 | −1 | 0 | 2 | 1 |
| | | | (0) | (1) | (0) | (0) | (0) | (0) | | | | | | |
| C-S-20, tomato | −. | 45 | 53 | 53 | 52 | 53 | 53 | 53 | | | | | | |
| | | | (0) | (0) | (0) | (0) | (0) | (0) | | | | | | |
| WFK 10 WB, | +. | 22 | 41 | 43 | 43 | 45 | 46 | 44 | −1 | 1 | 1 | 1 | 2 | 1 |
| blueberry juice | | | (1) | (0) | (1) | (0) | (0) | (1) | | | | | | |
| WFK 10 WB, | −. | 22 | 42 | 42 | 42 | 44 | 44 | 43 | | | | | | |
| blueberry juice | | | (0) | (0) | (0) | (0) | (1) | (0) | | | | | | |
| C-S-27, potato | +. | 19 | 50 | 51 | 52 | 54 | 55 | 58 | 23 | 23 | 23 | 24 | 25 | 29 |
| starch | | | (0) | (1) | (1) | (0) | (0) | (1) | | | | | | |
| C-S-27, potato | −. | 19 | 27 | 28 | 29 | 30 | 29 | 30 | | | | | | |
| starch | | | (0) | (1) | (1) | (0) | (2) | (0) | | | | | | |
| C-S-28, rice | +. | 21 | 48 | 48 | 48 | 50 | 51 | 53 | 19 | 19 | 18 | 19 | 20 | 22 |
| starch | | | (0) | (0) | (2) | (1) | (0) | (1) | | | | | | |
| C-S-28, rice | −. | 21 | 29 | 29 | 30 | 31 | 31 | 31 | | | | | | |
| starch | | | (1) | (1) | (0) | (0) | (0) | (1) | | | | | | |
| P01KC, tangerine | +. | 38 | 75 | 75 | 73 | 74 | 74 | 77 | 23 | 25 | 28 | 31 | 31 | 35 |
| | | | (1) | (0) | (0) | (1) | (0) | (1) | | | | | | |
| P01KC, tangerine | −. | 38 | 52 | 50 | 45 | 44 | 43 | 42 | | | | | | |
| | | | (0) | (1) | (1) | (1) | (0) | (2) | | | | | | |
| C-S-06, salad | +. | 39 | 45 | 46 | 46 | 47 | 49 | 52 | 3 | 4 | 4 | 4 | 7 | 9 |
| sressing | | | (0) | (1) | (0) | (0) | (1) | (1) | | | | | | |
| C-S-06, salad | −. | 39 | 42 | 42 | 42 | 42 | 42 | 42 | | | | | | |
| sressing | | | (1) | (1) | (0) | (0) | (2) | (0) | | | | | | |
| WFK 10 A, cotton | +. | 81 | 72 | 72 | 72 | 72 | 72 | 73 | −1 | 0 | 0 | 0 | 1 | 0 |
| | | | (0) | (0) | (1) | (0) | (0) | (0) | | | | | | |
| WFK 10 A, cotton | −. | 81 | 72 | 72 | 72 | 72 | 72 | 73 | | | | | | |
| | | | (0) | (0) | (0) | (0) | (0) | (0) | | | | | | |
| WFK 30 A, | +. | 79 | 68 | 70 | 71 | 66 | 69 | 67 | 1 | 1 | 2 | −1 | 0 | 0 |
| polyester | | | (2) | (0) | (1) | (1) | (1) | (0) | | | | | | |
| WFK 30 A, | −. | 79 | 67 | 69 | 69 | 68 | 68 | 66 | | | | | | |
| polyester | | | (0) | (1) | (1) | (1) | (1) | (0) | | | | | | |

It is evident that the swatches with relevant enzyme sensitive substrate like protein, lipid, starch and other carbohydrate containing stains are responding nicely at approximately all salt concentrations. It was expected that the washing performance will decrease if wash was done at very high salt concentrations. In this case we have used a detergent composition of primarily nonionic surfactants. These surfactants are not as negatively influenced by the salts content as anionic surfactants would be.

Surprisingly, we can see that an enzyme cocktail of Protease, Lipase, Cellulase, Mannanase and Pectate lyase gives very nice benefits at salt concentration that are as high as Pacific ocean sea water (3.5%). The enzyme performance is not marked ly influenced by the salt content.

### Example 2

| provider | Name of swatches used in the test |
|---|---|
| EMPA | EMPA 112, milk/cocoa |
| | EMPA 118/1 |
| | Wfk 20 MU, Make-up |
| | Wfk 10 D, pigment/sebum |
| | EMPA 120 Cotton soiled with grease/quartz/iron oxide |
| | EMPA 106, oil/carbon black |
| | Wfk 10 TE, clay |
| | EMPA 101, olive oil/carbon black |
| | EMPA 116, blood/milk |
| | EMPA 117, blood/milk/ink |
| | EMPA 164, grass |
| | EMPA 114, red wine |
| | Wfk 10 U, curry |
| | C-S-20, tomato |
| | Wfk 10 WB, Blueberry Juice |
| | C-S-27, potato starch |
| | C-S-28, rice starch |
| | Wfk 10 A, 100% cotton, pre-washed |
| | Wfk 30 A, 100% polyester, pre-washed |

| DETERGENT composition | | |
|---|---|---|
| Name | Dosage | |
| sodium dodecylbenzenesulfonate | 0.9 | g/L |
| Na₂CO₃ | 4 | mM |
| Na₂HC0₃ | 4 | mM |

NaCl g per 600 mL wash liquor:

| % | gram |
|---|---|
| 3.5 | 21 |
| 3 | 18 |
| 2 | 12 |
| 1 | 6 |
| 0.5 | 3 |

| | Dosage (ppm | Required amount of |
|---|---|---|
| | active enzyme | enzyme product per |
| Name | protein) | liter wash solution (g) |
| Lipase as defined | 0.34 | 0.0172 |
| in SEQ ID NO: 2 | | |
| Protease as shown | 3.20 | 0.0768 |
| in SEQ ID NO: 1 | | |
| Amylase as shown | 1.50 | 0.1080 |
| in SEQ ID NO: 3 | | |
| Cellulase as shown | 1.50 | 0.094 |
| in SEQ ID NO: 5 | | |

TOM wash
Textile amount:
20 g (Incl. ballast of 50% Polyester and 50% Cotton)
Tracers are 2 swatches of wfk 10A and 30A
Water hardness: 15° dH
Wash temperature: 20° C.
Dry overnight and measure remission at 460 nm
Wash time: 20 min
Wash with NaCl dose (0-3.5%) as stated above
Rinse in 2 × 600 ml water with corresponding salinity

Procedure for TOM wash, all washes was done in repetition:
1. The heating bath in TOM was turned on at 30° C.
2. Beakers and stir bars were placed in the TOM and 600 ml detergent solution was added
3. The agitation was set to 110 rpm.
4. The detergent composition and NaCl was weighed of and dissolved for 5 minutes while agitation was on
5. The textile swatches were added to the beakers and the washes were started for those beaker washed without enzymes
6. For the beakers washed with enzymes the washes started when the enzymes were added to the beakers directly after the textiles
7. Each beaker washed for 20 minutes before agitation was stopped and the wash water discarded; swatches was squeezed and added back in the TOM beaker.
8. Rinse was started when 400 mL cold tap water with correspondent salinity and agitation of 110 rpm was applied
9. The rinse should run for 5 min
10. After the rinse, the water was discarded and the swatches were placed in a sieve to let the water drip off and the swatches sorted.
11. All marked swatches are put on a tray covered with paper and topped with another layer of paper, and dried overnight.
13. Calculation of results was done by subtracting the remission results from was with enzymes from wash without enzymes.
   Results are shown in the tables below.

TABLE 2

| | | | Remission after wash | | | | | |
|---|---|---|---|---|---|---|---|---|
| | | | 21 g | 18 g | 12 g | 6 g | 3 g | 0 g |
| Swatches | enzymes | Unwashed | NaCL | NaCL | NaCL | NaCL | NaCL | NaCL |
| EMPA101 olive | with | 15 | 18 | 18 | 17 | 18 | 19 | 20 |
| oil/carbon black | | | | | | | | |
| EMPA101 olive | without | 15 | 17 | 18 | 16 | 19 | 19 | 21 |
| oil/carbon black | | | | | | | | |
| EMPA106 motor oil | with | 26 | 34 | 35 | 34 | 37 | 37 | 35 |
| EMPA106 motor oil | without | 26 | 36 | 31 | 33 | 31 | 31 | 37 |
| EMPA112 coca on | with | 27 | 39 | 37 | 39 | 41 | 45 | 46 |
| cotton | | | | | | | | |
| EMPA112 coca on | without | 27 | 31 | 33 | 28 | 33 | 33 | 31 |
| cotton | | | | | | | | |
| EMPA114 red wine | with | 42 | 47 | 47 | 48 | 49 | 49 | 47 |
| EMPA114 red wine | without | 42 | 46 | 47 | 48 | 48 | 48 | 47 |
| EMPA116 blod/milk | with | 12 | 19 | 18 | 20 | 21 | 30 | 35 |
| EMPA116 blod/milk | without | 12 | 16 | 17 | 17 | 18 | 20 | 23 |
| EMPA117 blood/milk/ink | with | 12 | 15 | 15 | 16 | 20 | 28 | 35 |
| EMPA117 blood/milk/ink | without | 12 | 13 | 14 | 14 | 15 | 16 | 17 |
| EMPA118 sebum/ | with | 46 | 50 | 47 | 48 | 52 | 50 | 50 |
| pigment | | | | | | | | |
| EMPA118 sebum/ | without | 46 | 49 | 50 | 47 | 47 | 48 | 52 |
| pigment | | | | | | | | |
| wfk 164 grass | with | 35 | 38 | 37 | 39 | 41 | 41 | 41 |
| wfk 164 grass | without | 35 | 35 | 37 | 38 | 39 | 37 | 37 |
| wfk 10U, curry | with | 61 | 65 | 65 | 66 | 67 | 68 | 69 |
| wfk 10U, curry | without | 61 | 65 | 66 | 66 | 67 | 66 | 69 |
| wfk 10D pigment/sebum | with | 44 | 51 | 52 | 55 | 58 | 60 | 60 |
| wfk 10D pigment/sebum | without | 44 | 51 | 52 | 54 | 58 | 59 | 58 |
| wfk 10TE clay | with | 57 | 62 | 61 | 63 | 65 | 66 | 67 |
| wfk 10TE clay | without | 57 | 60 | 62 | 63 | 63 | 66 | 68 |
| CS-20 tomato | with | 40 | 50 | 50 | 51 | 53 | 54 | 55 |
| CS-20 tomato | without | 40 | 49 | 50 | 51 | 52 | 52 | 52 |
| wfk 20MU, makeup | with | 50 | 58 | 59 | 60 | 63 | 63 | 62 |
| wfk 20MU, makeup | without | 50 | 58 | 59 | 59 | 61 | 63 | 63 |
| CS-27 potato starch | with | 16 | 33 | 34 | 35 | 37 | 38 | 43 |
| CS-27 potato starch | without | 16 | 22 | 22 | 22 | 23 | 23 | 25 |
| CS-28 rice starch | with | 17 | 34 | 35 | 36 | 37 | 40 | 42 |
| CS-28 rice starch | without | 17 | 25 | 25 | 23 | 24 | 25 | 26 |
| WFK10 WB blueberry | with | 24 | 37 | 37 | 38 | 40 | 41 | 40 |
| juice | | | | | | | | |
| WFK10 WB blueberry | without | 24 | 36 | 36 | 38 | 39 | 40 | 40 |
| juice | | | | | | | | |
| EMPA120 lard/ | with | 14 | 25 | 25 | 25 | 29 | 27 | 24 |
| ferricoxide | | | | | | | | |
| EMPA120 lard/ | without | 14 | 20 | 23 | 26 | 21 | 28 | 22 |
| ferricoxide | | | | | | | | |
| wfk10A, 100% cotton, | with | 77 | 72 | 72 | 73 | 75 | 76 | 77 |
| prewashed | | | | | | | | |
| wfk10A, 100% cotton, | without | 77 | 72 | 73 | 73 | 75 | 76 | 78 |
| prewashed | | | | | | | | |
| wfk30A, 100% polyester, | with | 78 | 72 | 73 | 73 | 75 | 75 | 75 |
| prewashed | | | | | | | | |
| wfk30A, 100% polyester, | without | 78 | 72 | 72 | 73 | 75 | 75 | 75 |
| prewashed | | | | | | | | |

Table 3 shows the wash performance:

| | | delta remission (with salt- without salt) | | | | | |
|---|---|---|---|---|---|---|---|
| | | 21 g | 18 g | 12 g | 6 g | 3 g | 0 g |
| Swatches | enzyme | NaCL | NaCL | NaCL | NaCL | NaCL | NaCL |
| EMPA101 olive oil/ | with | −2 | −3 | −3 | −2 | −1 | 0 |
| carbon black | | | | | | | |
| EMPA101 olive oil/ | without | −4 | −3 | −5 | −2 | −2 | 0 |
| carbon black | | | | | | | |
| EMPA106 motor oil | with | −1 | 0 | −1 | 1 | 2 | 0 |
| EMPA106 motor oil | without | −1 | −5 | −4 | −6 | −6 | 0 |
| EMPA112 cocoa on | with | −8 | −9 | −8 | −5 | −2 | 0 |
| cotton | | | | | | | |
| EMPA112 cocoa on | without | −1 | 1 | −4 | 2 | 1 | 0 |
| cotton | | | | | | | |
| EMPA114 red wine | with | 0 | 0 | 1 | 2 | 2 | 0 |
| EMPA114 red wine | without | −1 | 0 | 1 | 1 | 1 | 0 |
| EMPA116 blod/milk | with | −16 | −17 | −15 | −14 | −5 | 0 |
| EMPA116 blod/milk | without | −8 | −7 | −6 | −5 | −3 | 0 |
| EMPA117 blood/ | with | −21 | −21 | −20 | −15 | −8 | 0 |
| milk/ink | | | | | | | |
| EMPA117 blood/ | without | −3 | −2 | −2 | 2 | 0 | 0 |
| milk/ink | | | | | | | |
| EMPA118 sebum/ | with | 0 | −3 | −2 | 2 | 0 | 0 |
| pigment | | | | | | | |
| EMPA118 sebum/ | without | −4 | −3 | −5 | −5 | −4 | 0 |
| pigment | | | | | | | |
| wfk 164 grass | with | −3 | −4 | −2 | 1 | 0 | 0 |
| wfk 164 grass | Without | −2 | 0 | 1 | 2 | 0 | 0 |
| wfk 10U, curry | with | −5 | −4 | −3 | −2 | −1 | 0 |
| wfk 10U, curry | without | −4 | −3 | −3 | −2 | −3 | 0 |
| wfk 10D pigment/ | with | −9 | −9 | −6 | −3 | −1 | 0 |
| sebum | | | | | | | |
| wfk 10D pigment/ | without | −8 | −6 | −4 | 0 | 1 | 0 |
| sebum | | | | | | | |
| wfk 10TE clay | with | −6 | −7 | −4 | −2 | −2 | 0 |
| wfk 10TE clay | without | −8 | −6 | −5 | −5 | −2 | 0 |
| CS-20 tomat | with | −5 | −5 | −4 | −2 | −1 | 0 |
| CS-20 tomat | without | −3 | −2 | −1 | 1 | 0 | 0 |
| wfk 20MU, makeup | with | −5 | −3 | −2 | 1 | 0 | 0 |
| wfk 20MU, makeup | without | −5 | −4 | −4 | −2 | 0 | 0 |
| CS-27 potato starch | with | −11 | −9 | −8 | −6 | −5 | 0 |
| CS-27 potato starch | without | −3 | −3 | −3 | −2 | −2 | 0 |
| CS-28 rice starch | with | −9 | −7 | −7 | −5 | −3 | 0 |
| CS-28 rice starch | without | −2 | −2 | −3 | −2 | −2 | 0 |
| WFK10 WB blue- | with | −3 | −3 | −2 | 0 | 1 | 0 |
| berry juice | | | | | | | |
| WFK10 WB blue- | without | −4 | −4 | −2 | −1 | 0 | 0 |
| berry juice | | | | | | | |
| EMPA120 lard/ | with | 0 | 0 | 1 | 5 | 2 | 0 |
| ferricoxide | | | | | | | |
| EMPA120 lard/ | without | −3 | 0 | 3 | −1 | 5 | 0 |
| ferricoxide | | | | | | | |
| wfk10A, 100% | with | −5 | −5 | −4 | −2 | −1 | 0 |
| cotton, prewashed | | | | | | | |
| wfk10A, 100% | without | −6 | −5 | −5 | −3 | −2 | 0 |
| cotton, prewashed | | | | | | | |
| wfk30A, 100% | with | −3 | −2 | −2 | 0 | 0 | 0 |
| polyester, prewashed | | | | | | | |
| wfk30A, 100% | without | −3 | −3 | −2 | −1 | 0 | 0 |
| polyester, prewashed | | | | | | | |

Table 4 shows the difference between wash with enzymes subtracted with the result from wash without enzymes at the different salt concentrations:

| | delta remission (with enz-without enz) | | | | | |
|---|---|---|---|---|---|---|
| | 21 g | 18 g | 12 g | 6 g | 3 g | 0 g |
| Swatches | NaCL | NaCL | NaCL | NaCL | NaCL | NaCL |
| EMPA101 olive oil/carbon black | 1 | 0 | 1 | −1 | 0 | 0 |
| EMPA106 motor oil | −1 | 4 | 1 | 6 | 6 | −2 |
| EMPA112 cocoa on cotton | 8 | 4 | 11 | 8 | 12 | 15 |
| EMPA114 red wine | 1 | 0 | 0 | 2 | 2 | 0 |
| EMPA116 blod/milk | 4 | 1 | 3 | 3 | 10 | 12 |
| EMPA117 blood/milk/ink | 2 | 1 | 1 | 5 | 12 | 19 |
| EMPA118 sebum/pigment | 1 | −3 | 0 | 5 | 1 | −3 |
| wfk 164 grass | 3 | 0 | 0 | 2 | 4 | 4 |
| wfk 10U, curry | −1 | −1 | 0 | 0 | 2 | 0 |
| wfk 10D pigment/sebum | 1 | −1 | 0 | −1 | 1 | 2 |
| wfk 10TE clay | 2 | −1 | 0 | 2 | 0 | −1 |
| CS-20 tomat | 1 | 0 | 1 | 1 | 2 | 3 |
| wfk 20MU, makeup | −1 | 0 | 1 | 2 | 0 | −1 |
| CS-27 potato starch | 11 | 11 | 13 | 14 | 15 | 18 |
| CS-28 rice starch | 9 | 11 | 13 | 13 | 15 | 16 |
| WFK10 WB blueberry juice | 1 | 1 | 0 | 1 | 1 | 0 |
| EMPA120 lard/ferricoxide | 5 | 2 | 0 | 7 | −1 | 2 |
| wfk10A, 100% cotton, | 0 | −1 | 0 | 0 | 0 | 0 |
| prewashed | | | | | | |
| wfk10A, 100% cotton, | 0 | 1 | 0 | 0 | 0 | 0 |
| prewashed | | | | | | |

Wash performance in LAS based detergent is very influenced by salt concentration. This can be observed by looking at the wash performance at 3.5% salt compared with 0% salt. This is reflected in table 3. This shows the difference in performance between a wash without salt and with the increasing amounts of salt. It is obvious that both with and without enzymes the performance is disturbed by the salt concentrations. Though, a closer look shows that the enzymes surprisingly can compensate some of the performance loss from NaCl. It is a surprise because LAS is an anionic surfactant that easily becomes occupied by CI⁻ and Na⁺ ions in the solution. In table 1 it is shown by the delta values how much the swatches becomes cleaner by adding enzymes. Especially the starch based stains called DS28 and CS 27 shows that the presence of amylase is giving a large boost to the performance when NaCl is added. Even at a 3.5% salt concentration the performance is very large and visible. Also protein based stains like Empa116; 117 and 112 is to large extent compensated by the protease added.

1. A method of washing or rinsing a laundry item, the method comprising combining one or more enzymes with water having a NaCl content of at least 0.05% at 20° C. and/or water having a BOD₅ value of at least above 3 mg O₂/L at 20° C.

2. The method of claim 1, wherein the enzymes are selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and xanthanase.

3. The method of claim 1, wherein the water is sea water.

4. The method of claim 1, wherein the water is waste water from domestic house hold, institutions or industry.

5. The method of claim 1, wherein the water has a BOD₅ value in the range of 3 mg O₂/L at 20° C. to 100 mg O₂/L at 20° C.

6. A detergent composition comprising an anionic surfactant, a builder and one or more enzymes selected from the group consisting of hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, chlorophyllases, amylases, perhydrolases, peroxidases and/or xanthanase, wherein the ratio between the anionic surfactant and the builder is in the range of 1:62.

7. The detergent composition according to claim 6, wherein the ratio between the anionic surfactant and the builder is in the range of 1:20 to 1:62.

8. The detergent composition according to claim 6, wherein the one or more enzymes are selected from the group consisting of protease, lipase, amylase, cellulase, pectate lyase and mannanase.

9. The detergent composition according to claim 6, wherein the anionic surfactant is selected from the group consisting of sulfates and sulfonates, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diyIbis(sulfates), hydroxyalkanesulfonates and disulfonates, alkyl sulfates (AS), sodium dodecyl sulfate (SDS), fatty alcohol sulfates (FAS), primary alcohol sulfates (PAS), alcohol ethersulfates (AES or AEOS or FES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid and salt of fatty acids (soap).

10. The detergent composition according to claim 6, wherein the concentration of the enzyme is at least 3.7×10⁻⁷ g enzyme protein per gram detergent composition.

11. A method for laundering a textile comprising the steps of:
a. Contacting the textile with a wash liquor comprising a detergent composition according to claim 6 and water having a NaCl content of at least 0.05% at 20° C. and/or water having a BOD₅ value of at least above 3 mg O₂/L at 20° C.;
b. Completing at least one wash cycle; and
c. Optionally rinsing the textile.

12. The method according to claim 11, wherein the water is sea water.

13. The method according to claim 11, wherein the water has a BOD₅ value in the range of 3 mg O₂/L at 20° C. to 100 mg O₂/L at 20° C.

14. The method according to claim 11, wherein the water is diluted with fresh water to obtain a lower content of NaCl and/or a lower BOD₅ value.

15. The method according to claim 11, wherein the concentration of the one or more enzyme in the wash liquor is at least 0.01 g of enzyme protein per liter wash liquor, such as at least 0.015 g of enzyme protein, at least 0.02 g of enzyme protein, at least 0.025 g of enzyme protein, at least 0.03 g of enzyme protein per liter wash liquor.
